(19) United States
(12) Patent Application Publication
(10) Pub. No.: US 2006/0227105 A1
(43) Pub. Date: Oct. 12, 2006

(54) Typing game apparatus

(75) Inventor: Junichi Kogo, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/395,976

(22) Filed: Apr. 3, 2006

(30) Foreign Application Priority Data
Apr. 7, 2005 (JP) 2005-111296

(51) Int. Cl. G09G 5/00

(52) U.S. Cl. 345/156

(57) ABSTRACT

With a typing game apparatus, it is possible to select a desired difficulty level setting with a difficulty level selection procedure, and, when the execution of the typing game is started, determination is made in a correctness determination procedure as to whether keys which have been input via a keyboard are correct, and as to whether the input timing of those keys is correct. At this time, in an input time period setting procedure, an input time period is set according to the difficulty level which has been set in the difficulty level selection procedure, and the correctness determination of the timing of key input is performed by comparing the input time period which has been set and the timing of the key input.

### RELATED APPLICATION

This application claims the priority of Japanese Patent Application No. 2005-111296 filed on Apr. 7, 2005 which is incorporated herein by reference.

### BACKGROUND OF THE INVENTION

1. Field of the Invention

The present invention relates to a typing game apparatus with which the input time period during which a character string can be input via a keyboard is stipulated, and in particular relates to a typing game apparatus with which it is made possible to change the setting of the width of this input time period.

2. Description of the Prior Art

From the past, typing games have been known in which the player inputs a character string displayed on display means such as a display, by using input means such as a keyboard, and competes in scoring and so on by the correctness/incorrectness ratio of the input result; and nowadays, such games are set up in game arcades and many players utilize and enjoy them.

With such a typing game, the character string is displayed on the display or the like one word at a time or one line at a time, and the player progresses through the game by inputting these character strings via the keyboard, but it is usual for the input time period during which he is able to input such a character string to be stipulated in stipulation units of character strings of one word or one line or the like. And, if this input time period has been exceeded, he is not able to perform input of the character string (the one word or one line character string) which is displayed on the display, and moreover no addition is made to his score.

Now, since a person who has attained a high level of skill at typing and is able to type using “blind touch” is able to input these character strings within the specified input time period, he is able to derive a sufficient amount of pleasure from the typing game.

However, a novice who is relatively inexperienced in typing technique is liable to search over the keyboard for the key which he must input, and often he needs to perform input while making such checks, so that it often happens that he needs a long time period for inputting the character string. In particular, if he is required to input a relatively long character string within the input time period, it often happens that the input time period runs out at a time point at which he is getting near to the second half of the character string. Accordingly, a novice at the typing game is not able to perform such key input within the input time period, and he becomes unable to acquire any score, since he has exceeded the input time period.

In other words, since a novice at the typing game is not able to perform input during the input time period, and is unable to acquire a significant score, it becomes impossible for him to derive much pleasure from the typing game. As a result, it often happens that such a novice at the typing game avoids the typing game, and accordingly the typing game undesirably becomes characterized as one which can only be played satisfactorily by that fraction of the players who are skilled at the typing game.

As inventions related to typing games which are also directed at typing game novices, and which can afford sufficient enjoyment even to players who are inexperienced at the technique of typing, there are the inventions described in Japanese Unexamined Patent Publication Nos. 2002-297166 and 2002-167142.

In the above-mentioned publication documents, there are described typing games with which, by making it possible to change the tempo at which a song is replayed, it is possible to change the time period between the input timing of a key and the input timing of the next key.

Since the lengths of the time periods between the input timings are changed in this manner by changing the tempo at which the song is replayed, it is possible, if the replay tempo is made slow, to provide a sufficiently long time period for a player who is a novice at the typing game to search for the correct keys, and to check them. As a result, with the typing games described in the above-mentioned publication documents, it is possible for a novice at the typing game to derive sufficient enjoyment while playing, as compared to the case of the previously described prior art typing game.

However, with the typing games described in the above-mentioned publication documents, even if the replay tempo for the song is changed, and the time period between the input timings is made longer, it is necessary for the player to perform key input at a timing which is approximately to the predetermined input timing, and, if he deviates much from this input timing, this constitutes an input mistake, just as with the prior art.

Furthermore although, with the typing games described in the above-mentioned publication documents, it is arranged for the player to input the lyrics for the song by typing on the keyboard along with the song being replayed, when a novice is playing the typing game, what happens is that the tempo at which the song is replayed changes, so that it comes to be replayed at a tempo which is different from the proper replay tempo for that song. In other words, the result occurs that a novice at the typing game executes the typing game in a state in which the song has lost some of the fascination that it should have. As a consequence there is the problem that, when a novice at the typing game is playing, the advantage of executing the typing game as the song is being replayed is undesirably diminished.

### SUMMARY OF THE INVENTION

The present invention has been conceived in the light of the above described problems, and it takes as its object, in relation to a typing game apparatus with which the input time period during which the player is capable of inputting a character string via the keyboard is stipulated, to provide such a typing game apparatus, which is capable of affording adequate pleasure even to a novice at the typing game, by, in particular, making it possible to change a setting for the width of the input time period.

In order to solve the problems, the invention according to Claim 1 is a typing game apparatus (for example, the typing game apparatus 1), comprising: display means (for example, the first liquid crystal display 3) on which a character string to be input is displayed; input means (for example, the keyboard 6) which inputs characters by operation by a player; storage means (for example, the HDD 55) which stores game data (for example, music data), including character string data displayed on the display means, and input time period data which indicates a time period for receiving input of the character string from the input means; game control means (for example, the CPU 51) which performs control of a typing game, based on the game data; timing determination means (for example, the CPU 51 and the correctness determination procedure of the step S38) which determines a correctness or incorrectness of input timing, based on the input time period data and information which indicates a time when input is performed by the input means; input time period selection means (for example, the CPU 51 and the difficulty level selection procedure of the step S5) which selects a length of an input time period; and input time period changing means (for example, the CPU 51 and the correctness determination procedure of the step S38), which changes the input time period based on a result of selection by the input time period selection means, wherein the timing determination means (for example, the CPU 51 and the correctness determination procedure of the step S38) determines the correctness or incorrectness of input timing by the input means, based on the input time period which has been changed by the input time period changing means.

Furthermore, the invention according to Claim 2 is the typing game apparatus of Claim 1 (for example, the typing game apparatus 1), wherein the game data (for example music data) includes music data based on a music performance related to a song, and the character string data comprises data which indicates a character string related to lyrics of a song.

Yet further, the game apparatuses of the other Claims have particular distinguishing features, as follows.

The typing game apparatus according to Claim 3 is the typing game apparatus of Claim 1, wherein, when selecting the input time period, a plurality of alternatives for the input time period data are displayed on the display.

Furthermore, the typing game apparatus according to Claim 4 is the typing game apparatus of Claim 3, wherein a selection of an input time period is performed according to an instruction input operation specifying that one input time period data is to be selected from among the plurality of alternatives for the input time period data displayed on the display.

Still further, the typing game apparatus according to Claim 5 is the typing game apparatus of Claim 3, wherein the plurality of alternatives for the input time period data comprise time period data indicating a first mode in which a permitted input time period is the longest, time period data indicating a second mode in which the permitted input time period is the shortest, and time period data indicating a thirds mode in which the permitted input time period is between the input time period indicated by the fist mode and the input time period indicated by the second mode.

Furthermore, the typing game apparatus according to Claim 6 is the typing game apparatus of Claim 1, wherein the input time period for a next typing game is changed according to a determination by the timing determination unit.

Further, the typing game apparatus according to Claim 7 is the typing game apparatus of Claim 1, wherein the display comprises a first display section which can display a character string which is to be input during the typing game, and a second display section which can display an image.

### BRIEF DESCRIPTION OF THE DRAWINGS

FIG. 1 is a perspective view of a typing game apparatus according to a preferred embodiment of the present invention;

FIGS. 2A and 2B are schematic figures showing the contents displayed on a first liquid crystal display before the start of the typing game: FIG. 2A is a schematic figure showing the first liquid crystal display with a difficulty level selection screen displayed thereon, while FIG. 2B is a schematic figure showing the first liquid crystal display with a song selection screen displayed thereon;

FIG. 3A is a schematic figure showing the contents displayed on the second liquid crystal display during the progression of the typing game, and FIG. 3B is a schematic figure showing contents displayed on the first liquid crystal display during the progression of the typing game;

FIG. 4A is a schematic figure showing the contents displayed on the second liquid crystal display during the progression of the typing game, and FIG. 4B is a schematic figure showing contents displayed on the first liquid crystal display during the progression of the typing game;

FIG. 5 is a schematic figure showing contents displayed on the first liquid crystal display after the typing game has terminated;

FIG. 6 is a plan view showing a keyboard which is provided to this typing game apparatus of this embodiment;

FIG. 7 is a schematic sectional view taken through one of a plurality of keys which are provided on the keyboard;

FIG. 8 is a system block diagram showing a system which consists of a server and a typing game apparatus according to this embodiment;

FIG. 9 is a block diagram, schematically showing a control system of the typing game apparatus according to this embodiment;

FIG. 10 is a schematic figure showing a music data storage region on a HDD of the typing game apparatus according to this embodiment;

FIG. 11 is a flow chart showing the flow of a main processing program of the typing game apparatus according to this embodiment;

FIG. 12 is a flow chart of a difficulty level selection processing program of the typing game apparatus according to this embodiment;

FIG. 13 is a flow chart of a song selection processing program of the typing game apparatus according to this embodiment;

FIG. 14 is a flow chart of a typing game execution processing program of the typing game apparatus according to this embodiment;

FIG. 15 is a flow chart of a correctness determination processing program of the typing game apparatus according to this embodiment; and

FIG. 16 is an explanatory figure related to an input time period determination procedure of the typing game apparatus according to this embodiment.

### DESCRIPTION OF THE PREFERRED EMBODIMENTS

In the following, the typing game apparatus according to the present invention will be explained in detail with reference to the drawings, based on a concrete embodiment thereof as a housing type typing game apparatus set up in a game arcade or the like.

This typing game apparatus 1 according to this embodiment is constituted so as, along with reproducing songs via a speaker, also to display the lyrics corresponding to the song which is reproduced in sequence on a display, and so that the player performs playing by typing the displayed lyrics in sequence on a keyboard. Moreover, the typing game which is implemented in practice consists of a plurality of stages corresponding to the number of verses in the song which is to be reproduced, and if, at the time point when one stage has been completed, the number of typing errors committed by the player is less than a predetermined number, then the game proceeds to a stage which corresponds to the next verse of the song, so that it is possible to perform the typing game continuously.

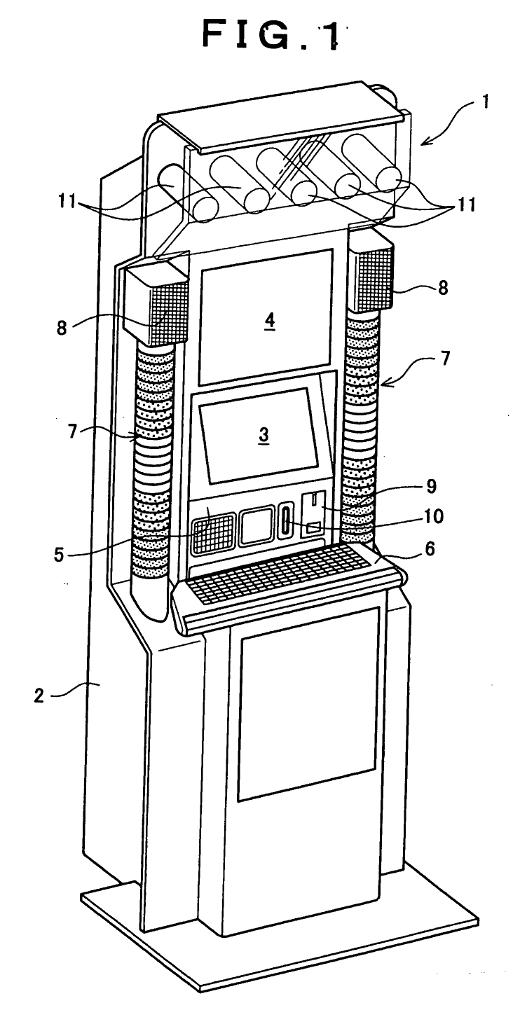

In the following, the overall structure of a typing game apparatus according to this embodiment will be explained with reference to FIG. 1. FIG. 1 is a perspective view of this typing game apparatus according to the present embodiment.

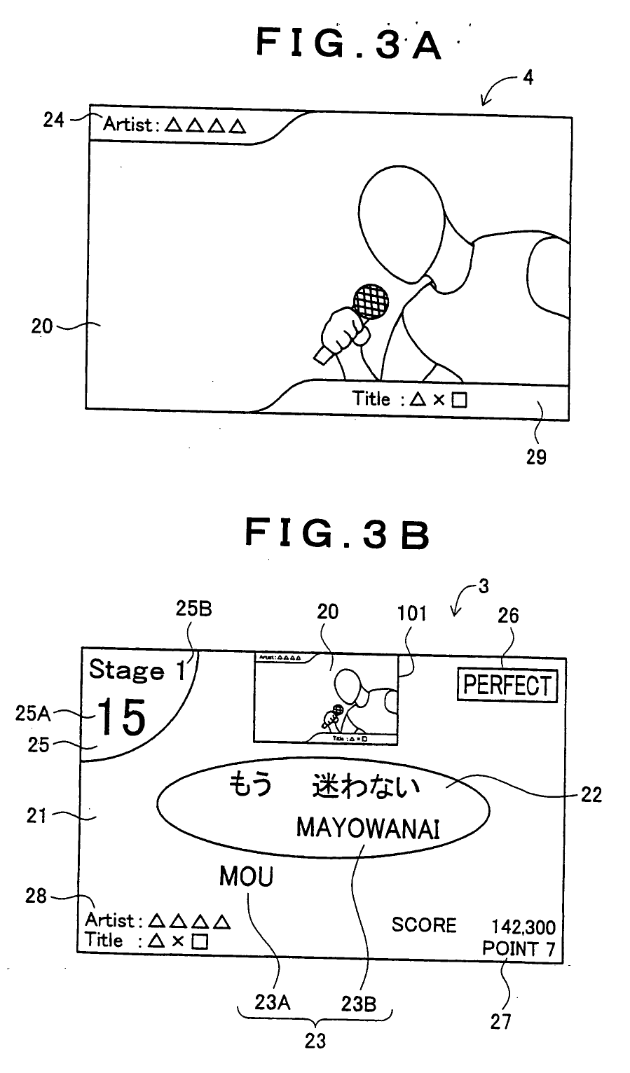

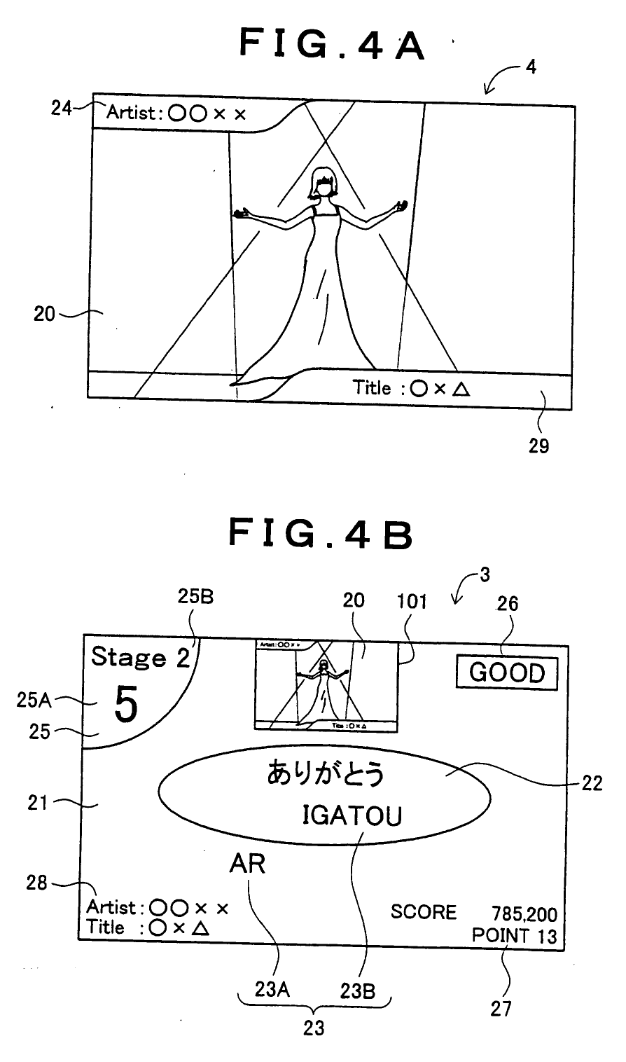

As shown in FIG. 1, the typing game apparatus 1 according to this embodiment fundamentally comprises: a housing 2 which constitutes the outer casing of the typing game apparatus 1; a first liquid crystal display 3 on which a main game screen (refer to FIGS. 3B and 4B) is displayed; a second liquid crystal display 4 which is positioned above the first liquid crystal display 3, and on which images related to effects such as promotion videos or advertisements or the like (refer to FIGS. 3A and 4A) are displayed; a center panel 5 which is provided below the first liquid crystal display 3, and in which insertion slots for coins and cards are formed; a keyboard 6 on which the player performs typing; a pair of illumination devices 7 which are provided to the left and the right of the front surface of the housing 2, a pair of speakers 8 which are provided to the left and the right of the second liquid crystal display 4, five spotlights 11 which are arranged above the second liquid crystal display 4, and the like. Each of these structural elements will now be explained.

The first liquid crystal display 3 is a liquid crystal display which is provided approximately at the central portion of the front surface of the housing 2 and which is disposed at a predetermined angular inclination, and it is arranged to incline rearward from the front surface at a predetermined angle.

And display is performed (refer to FIG. 3B and FIG. 4B) on this first liquid crystal display 3 of the lyrics of a song which is reproduced via the speakers 8 during the execution of the typing game, of the results of typing by the player, and of playing information related to the progression of the typing game (information which the player needs during the progression of the game) such as the score obtained and the like.

On the other hand, the second liquid crystal display 4 which is provided separately above the first liquid crystal display 3 is a liquid crystal display of the same type as the first liquid crystal display 3, and, during execution of a typing game, effect images related to effects for the typing game are displayed on this second liquid crystal display 4.

Here, the contents of the effect images displayed on the second liquid crystal display 4 are basically different from those which are displayed on the above described first liquid crystal display 3, and, while they are not directly required by the player to progress in the game, they fulfill a support role in order to reach the climax of the typing game.

For example as, with the typing game apparatus 1 according to this embodiment, a song by a vocalist is reproduced as the song, and the game progresses by the player performing input of the lyrics of the song via the keyboard 6, meanwhile a promotion video (hereinafter abbreviated as a “PV”) related to this song is displayed on the second liquid crystal display 4 (refer to FIGS. 3A and 4A). Accordingly, it becomes possible to present the typing game in a manner in which, along with the song being played, a presence is projected of the figure of the artist singing, so that the player does not become bored.

It should be understood that the contents of the displays provided on the first liquid crystal display 3 and on the second liquid crystal display 4 will be explained in detail hereinafter.

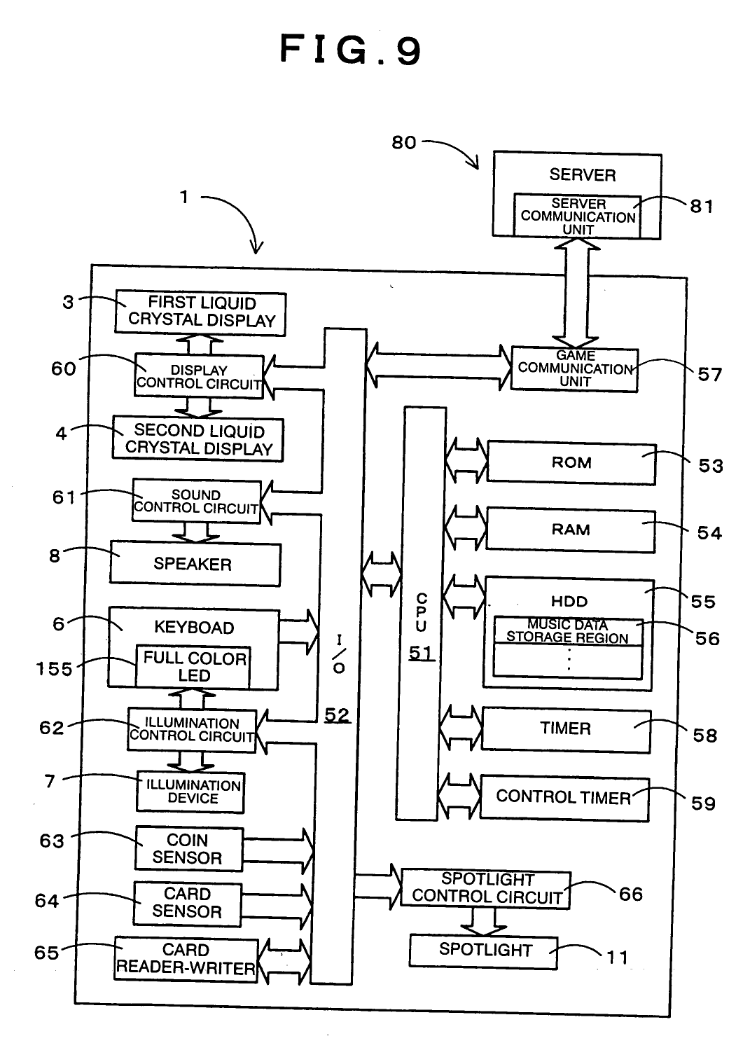

Furthermore, a coin insertion slot 9 and a card insertion slot 10 are provided on the center panel 5. The coin insertion slot 9 is an insertion slot in which a coin such as a 100 yen coin or the like is inserted. A coin sensor 63 is provided to this coin insertion slot 9, and, when a coin is inserted into the coin insertion slot 9, a coin detection signal is output via the coin sensor 63 to a CPU 51 (refer to FIG. 9). And the CPU 51 detects that a coin has been inserted, based on this coin detection signal.

The card insertion slot 10 is an insertion slot for the insertion of an IC card (not shown in the figure) bearing an IC tag on which a game result for the typing game is recorded. In the interior of this card insertion slot 10, there are disposed a card sensor 64 and a card reader-writer 65 which will be described hereinafter (refer to FIG. 9).

Here, the IC card which is used in the typing game apparatus 1 according to this embodiment stores in the incorporated IC tag the game results (the score acquired and the points and so on) for the previous games of the player who owns the card, up to and through the previous one.

And, if an IC card has been inserted into the card insertion slot 10, the card sensor 64 detects this fact. Furthermore, the card reader-writer 65 is able to perform reading out of the results of typing games which are stored in the IC tag incorporated in the IC card, and to perform writing in of the result of a game executed by the player to the IC tag.

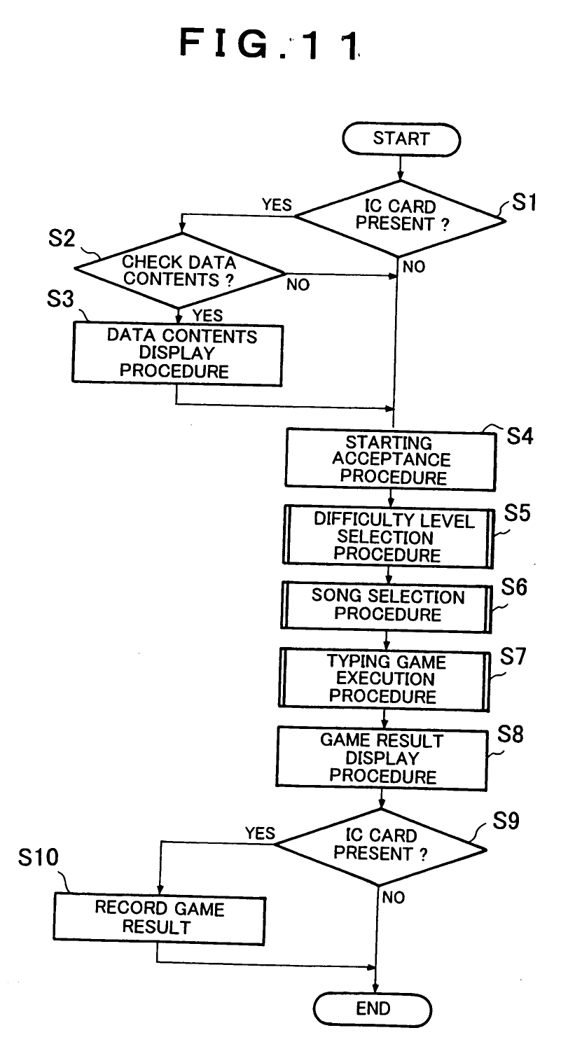

In other words, by performing a predetermined operating procedure when an IC card is inserted into the card insertion slot 10, it is possible to read out the results of games from the IC tag, and to display them with the typing game apparatus 1 (in the step S3 of FIG. 11). By doing this, the player is able to check the history of his own playing information. Furthermore, when the execution of the typing game has been completed, the result of this game can be stored on the IC tag (in the step S10 of FIG. 11).

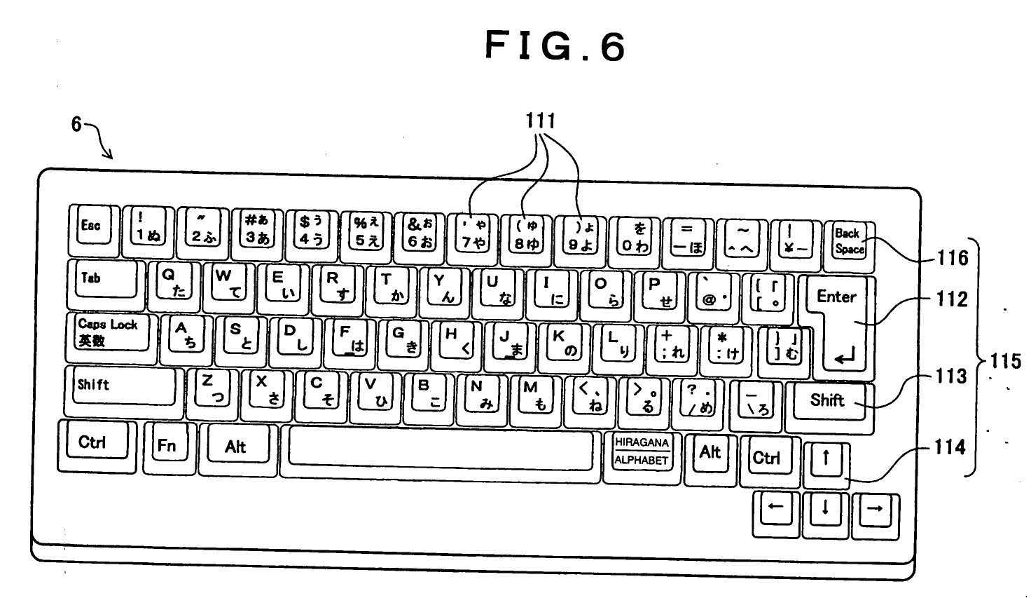

Furthermore, the keyboard 6 is a 108 key Japanese keyboard (refer to FIG. 6), which is disposed so as to project forward from the front surface of the housing 2, and on which, as will be described hereinafter, there are arrayed a plurality of character input keys which perform input of Alphabet letters (A through Z), kanas (Japanese syllabic characters) (“a” through “n”), digits (0 through 9), punctuation symbols (period and comma), and so on, and function keys such as an enter key, cursor keys, and so on. And, during the game, the player makes progress in the game by performing character input by typing various keys which correspond to characters, symbols, digits, and the like. Moreover, before the start of play or after the end of play, based on the operation of various keys, he performs selection of the song for which to perform the game and determination of the difficulty level of the game, and issue of a command to start the execution of a game and so on. It should be understood that the structure of the keyboard will be described in detail hereinafter.

Furthermore, a pair of illumination devices 7 are disposed on each of the left and right side surfaces of the housing 2. Each of these illumination devices 7 is formed from a cylindrical translucent member, 24 full color LEDs which can be illuminated in full color, and a light shielding member.

Each of these cylindrical translucent members is formed as a cylindrical tube from a stack of lenticular lenses, and is fixed to the housing 2 so that the longitudinal directions of the cylinder are vertical. Furthermore, the 24 full color LEDs are fixed to the light intercepting member at equal intervals in its longitudinal direction. And this light shielding member with the 24 full color LEDs fixed thereto is inserted into the interior of the shielding member. Accordingly the 24 full color LEDs are held in the interior of the illumination device 7, arranged at equal intervals in its longitudinal direction.

With the illumination devices 7 having this type of structure, when one of the full color LEDs is illuminated, due to the beneficial effect of the lenticular lenses of the translucent member, it is possible for it to appear, from the exterior, in a ring shaped illumination state (hereinafter termed a “light emitting ring”) extending in the horizontal direction.

In other words, by controlling the illumination states of the 24 full color LEDs, it is possible for a maximum of 24 light emitting rings to appear as being stacked over one another in the vertical direction, so that a large number of different illumination effects can be created according to the song which is reproduced by the typing game apparatus 1, with these illumination effects being provided according to the manner in which the player types. For example, as such illumination effects, it is possible to provide an effect of changing the positions or the illumination colors of the light emitting rings, an effect of making changes to the positions or the illumination colors of the light emitting rings according to a fixed rule, an effect of turning the light emitting rings on and off, or the like.

Furthermore, speakers 8 are provided on the left and right sides of the second liquid crystal display 4. These speakers 8 are output devices which output the song which is reproduced by the typing game apparatus 1, or effect sounds or the like. In concrete terms, during the execution of the typing game, the accompaniment music and the voice of the artist who is singing are output at a specified tempo, based on the voice data and the musical accompaniment data for the song which are stored in a HDD 55 (refer to FIG. 9).

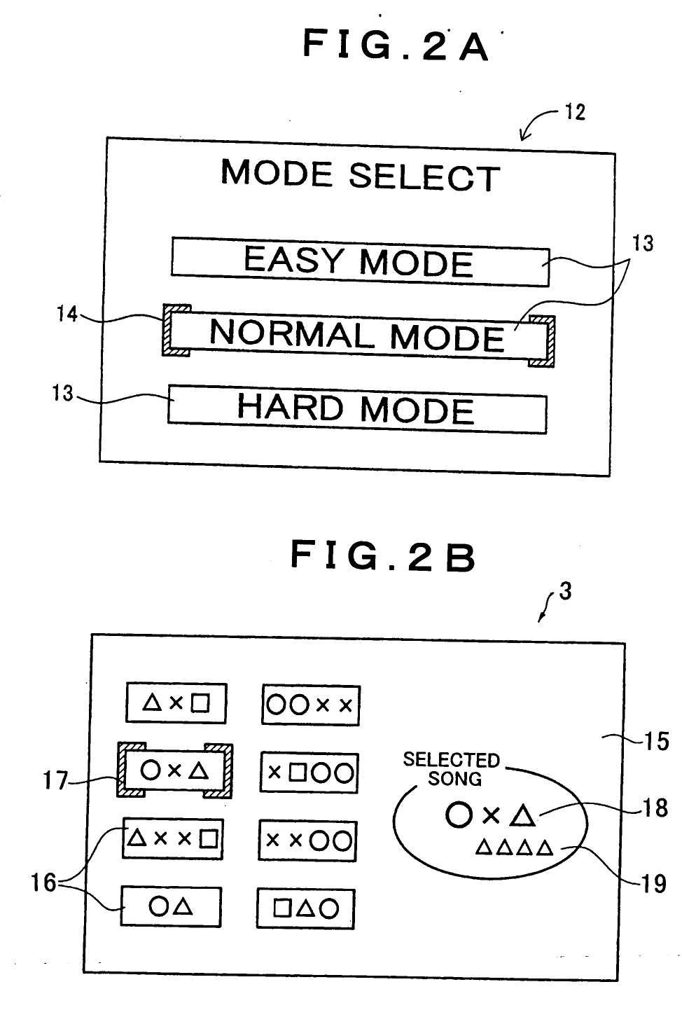

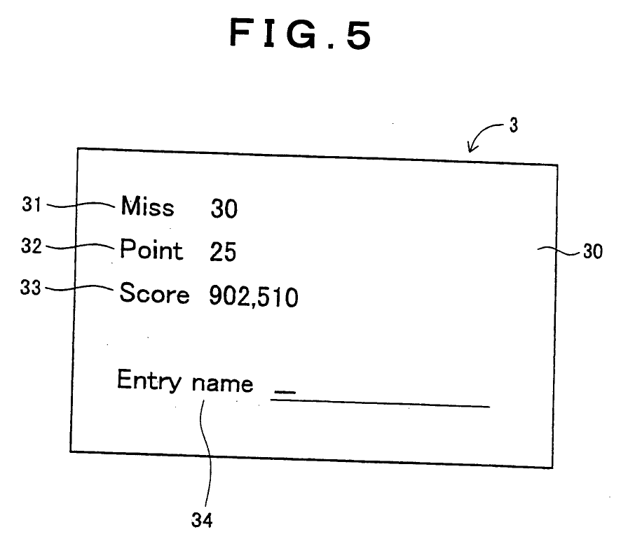

Next, the contents of the displays which are displayed on the first liquid crystal display 3 and the second liquid crystal display 4 will be explained in detail with reference to FIGS. 2 through 5. It should be understood that the contents of the displays which are displayed by the first liquid crystal display 3 and the second liquid crystal display 4 fundamentally consist of three patterns: one pattern before the start of the typing game, one pattern during the execution of the typing game, and one pattern after the end of the typing game. FIGS. 2A and 2B are schematic figures showing the details of displays which are displayed on the first liquid crystal display 3 before the start of the typing game. And FIGS. 3A and 4A are schematic figures showing the details of displays which are displayed on the second liquid crystal display 4 during the execution of the typing game, while FIGS. 3B and 4B are schematic figures showing the details of displays which are displayed on the first liquid crystal display 3 during the execution of the typing game. Furthermore, FIG. 5 is a schematic figure showing the details of a display which is displayed on the first liquid crystal display 3 after the end of the typing game.

Thus, with the typing game apparatus 1 according to this embodiment, the typing game is performed by inputting the lyrics of a song which is played.

In concrete terms, first, the player selects a desired difficulty level from among three steps of difficulty levels which will be described hereinafter; and then, from among a plurality of songs which are made available, the player selects the song with which he desires to play. And, when the typing game starts, the musical accompaniment data corresponding to the accompaniment music of the song which has been selected and the voice data corresponding to the singing voice of the artist of that song are reproduced. Moreover, along with the reproduction of the musical accompaniment data and the voice data of the song, the lyrics of the song are displayed one phrase at a time as character strings which the player must input, together with the voice data which is reproduced.

The typing game progresses by the player inputting, via the keyboard 6, the character strings which correspond to these single phrases of the lyrics which are displayed, and, when play has terminated, based on various parameters related to the typing, such as the accuracy of the typing, the timing at which it has been input, and the like, the results of the typing game (the number of typing errors, the score acquired, the points and so on) are calculated and are displayed. In other words, the typing game on this typing game apparatus 1 is performed by the player competing in the degree of skill related to typing input during the game, while enjoying the song which is played during the game.

First, the contents of the display before the start of the typing game will be explained with reference to FIG. 2. After insertion of a coin or coins to a predetermined monetary value into the coin insertion slot 9, first, before the start of the typing game, on the first liquid crystal display 3, there is displayed a difficulty level setting screen 12, on which the player selects a difficulty level for the typing game on this typing game apparatus 1, as shown in FIG. 2A.

This difficulty level selection screen 12 consists of a plurality of difficulty level display sections 13 on which various difficulty levels for this typing game are displayed, and a difficulty level selection cursor 14 which can select any one of these difficulty level display sections 13.

The difficulty level display sections 13 are fields which indicate difficulty level settings for the typing game which is to be performed this time.

With the typing game apparatus 1 according to this embodiment, it is possible to execute the typing game at three difficulty level settings: “EASY MODE” (a first mode), “NORMAL MODE” (a third mode), and “HARD MODE” (a second mode).

Here, each of these difficulty level settings will be explained in a simple manner. First, “HARD MODE” is a game mode in which, if key input corresponding to the singing voice of the artist of the song is not performed approximately synchronously with that voice, it is determined that the key input timing has been missed, so that it is not possible to acquire a high score. Accordingly, this “HARD MODE” is a game mode for a high level person who is skilful at the typing game, since it is difficult for the player to perform input after having checked the keyboard 6.

And, “EASY MODE” is a game mode in which it is determined that effective key input has been performed, even if the timing of the key input by the player and the timing of key input which is stipulated according to the timing which is generated by the voice of the artist are spaced apart by a predetermined time period (in this embodiment, 0.5 seconds before and after the key input timing). Accordingly, in this “EASY MODE”, it is possible for the player to perform key input with time to spare, as compared to the case of the previously described “HARD MODE”. In other words, even the player who is not used to inputting with the keyboard 6, as for example if he is a novice at the typing game who performs input while checking his own keystrokes, he is still able to derive sufficient pleasure from the typing game.

Moreover, “NORMAL MODE” is a game mode in which, while a greater deviation is permitted in the key input timing than in “HARD MODE”, the time period during which the timing is allowed to deviate is shorter than in “EASY MODE”. Accordingly, in this “NORMAL MODE”, it is necessary for the player to perform key input at a more correct timing than in “EASY MODE”, but the timing is not determined as precisely as in “HARD MODE”. Thus, this is a game mode aimed at a person of middling ability with regard to the typing game.

It should be understood that these difficulty level settings will be explained in detail hereinafter with reference to the figures.

When, on the difficulty level dselection screen 12, by operation of the keyboard 6, one of the game modes “EASY MODE”, “NORMAL MODE”, and “HARD MODE” has been selected with the difficulty level selection cursor 14, then a song selection screen 15 shown in FIG. 2B is displayed.

This song selection screen 15 comprises: playable song name display sections 16 in which are displayed the names of songs which can be played; a song selection cursor 17 with which any one of the playable song name display sections 16 may be selected; a selected song name display section 18 in which is displayed the name of the song which is selected by the song selection cursor 17; and a selected artist name display section 19 in which is displayed the name of the artist of the song which is selected by the song selection cursor 17.

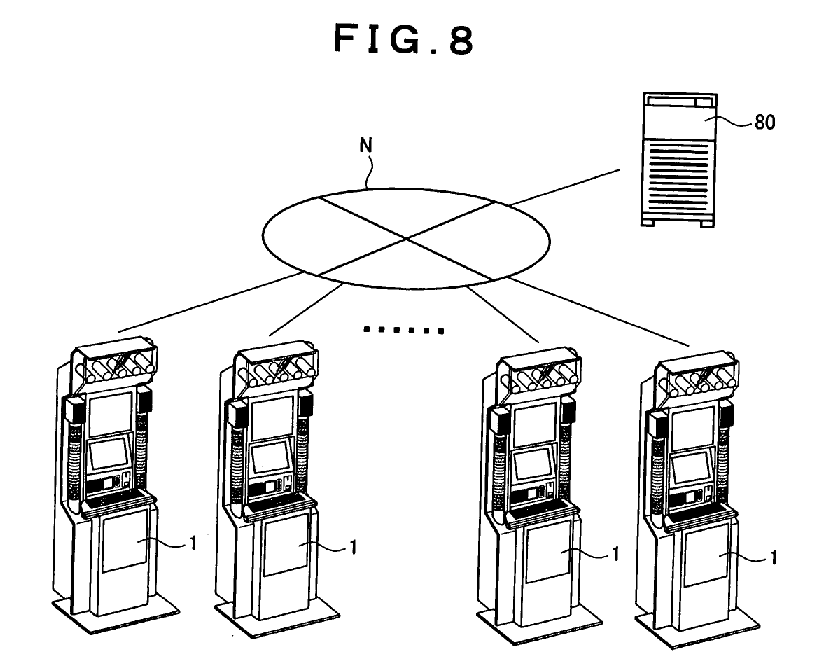

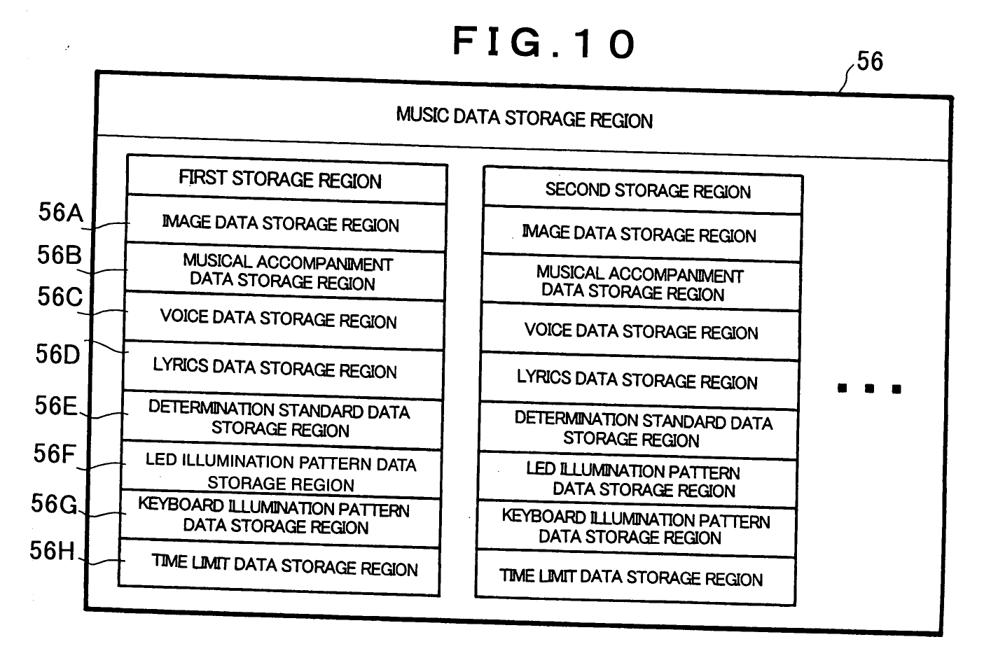

Here, each of the playable song name display sections 16 displays the name of a song (in this embodiment, a maximum of eight song names) which can be played at the present time by this typing game apparatus 1. These songs which are displayed in the playable song name display sections 16 and which can be played are songs for which the music data is stored on the HDD 55, as will be described hereinafter (refer to FIGS. 9 and 10), and moreover the music data which is stored is managed by a server 80 (refer to FIG. 8), and is periodically updated. Accordingly, it is possible for the player to perform playing by selecting from among a plurality of songs, including new songs which have been updated by the server 80. It should be understood that it would be acceptable, not only to display the names of the songs in the playable song name display sections 16, but to arrange also to display photographs of their artists, or PVs.

Furthermore, it is possible to shift the song selection cursor 17 upwards and downwards, and left and right, over the playable song name sections 16 by operating the cursor keys 114 on the keyboard 6 (refer to FIG. 6), so that the name of the song in that one of the playable song name display sections 16 at which the song selection cursor 17 is currently positioned, and the name of the artist of that song, are displayed in the selected song name display section 18 and the selected artist name display section 19, respectively.

And, when the enter key 112 (refer to FIG. 6) is pressed down in the state in which the song selection cursor 17 is positioned over that one of the playable song name display sections 16 in which the name of the desired song is displayed, then the song which is to be performed for the typing game is determined, and the typing game starts.

It should be understood that, while the difficulty level selection screen 12 and the song selection screen 15 are being displayed on the first liquid crystal display 3, a PV of any desired song may be running on the second liquid crystal display 4. Furthermore, an image of an advertisement or the like may also be displayed. Yet further, it may be arranged to display the difficulty level selection screen 12 and the song selection screen 15, not on the first liquid crystal display 3, but rather on the second liquid crystal display 4.

Next, the contents of displays provided during the execution of the typing game will be explained with reference to FIGS. 3 and 4. FIGS. 3A and 3B are explanatory figures respectively showing the display contents of the first liquid crystal display 3 and the second liquid crystal display 4 when a song (a) by a male artist has been selected on the song selection screen 15 and the typing game has started, while FIGS. 4A and 4B are explanatory figures respectively showing the display contents of the first liquid crystal display 3 and the second liquid crystal display 4 when a predetermined song (b) by a female artist has been selected on the song selection screen 15 and the typing game has started.

As shown in FIG. 3A, when the song (a) has been selected and the game has started, an image 20 of a PV of the male artist who sings the song (a) is displayed on the second liquid crystal display 4 while being played via the speakers 8. On the other hand, as shown in FIG. 4A, when the song (b) has been selected and the game has started, an image 20 of a PV of the female artist who sings the song (b) is displayed on the second liquid crystal display 4 while being played via the speakers 8.

On the other hand, as shown in FIGS. 3B and 4B, in parallel with the display of the image 20 of the PV on the second liquid crystal display 4, a main game screen 21 which is related to the progression of the typing game is displayed on the first liquid crystal display 3.

Here, this main game screen 21 is made up from: a lyrics display section 22 which displays the lyrics of the phrase which is currently being performed in Japanese kanji characters and/or kana or the like; a Alphabet letters display section 23 which, along with displaying the lyrics which are displayed in the lyrics display section 22 separately in Japanese using Alphabet letters, also displays in Alphabet letters the result of inputting which the player has input by typing on the keyboard 6; a song state display section 25 which displays to which number verse (i.e. to which stage), and moreover to which number phrase, counting from when this verse started, the phrase of the lyrics which is currently being displayed in the lyrics display section 22 and in the Alphabet letters display section 23 corresponds; a typing result display section 26 which displays the results of determination of correctness or incorrectness of the typing by the player; a score display section 27 which displays the score which the player has acquired up until the present moment and his points and the like; and a song information display section 28 in which are displayed the name of the artist and the title of the song which is currently being played.

The lyrics display section 22 is a display section on which are displayed a single phrase of the lyrics of the song which is currently being played. Accordingly, the game progresses by the player inputting the lyrics which are displayed in the lyrics display section 22 via the keyboard 6.

And if the player types the lyrics which are being displayed correctly the score steadily adds up, whereas, if he has input the lyrics incorrectly, no score is added, but rather the number of errors is increased by the number of input errors which he has additionally committed.

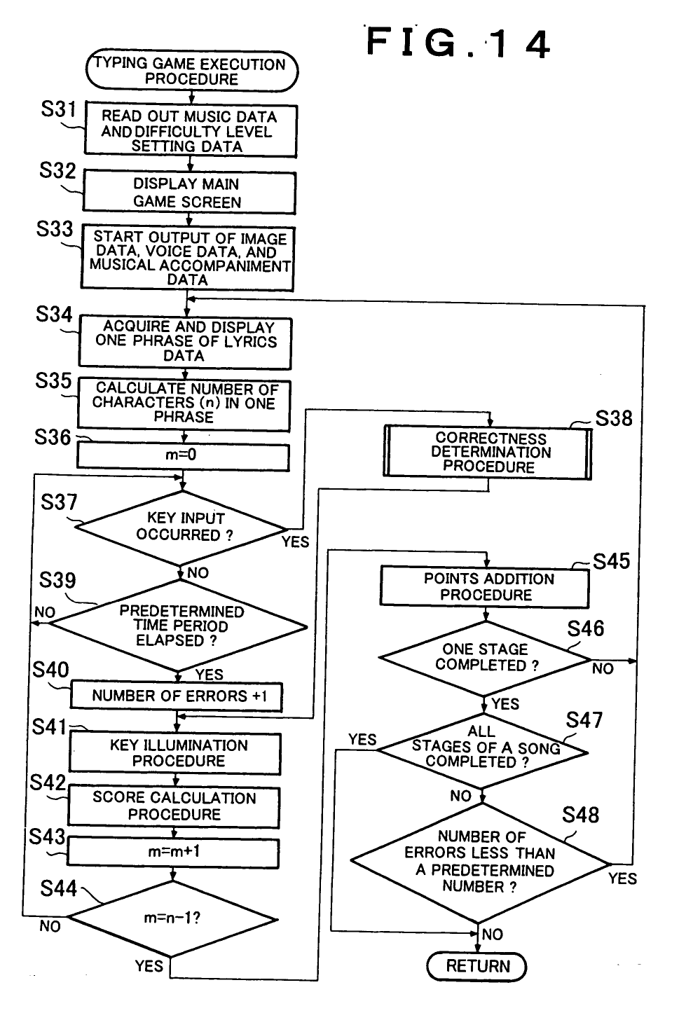

If within any verse (stage) making up the song, when any verse finishes, this number of typing errors reaches or exceeds a predetermined number, then the game terminates at that time point (refer to S48 of FIG. 14).

One phrase of the lyrics of the song which is currently being performed is displayed on the Alphabet letters display section 23, just as with the lyrics display section 22, but here the same lyrics are displayed as written in Alphabet letters. Furthermore, the characters which the player has typed up until now may be notified to him by displaying, among the shown lyrics, that character string 23A which has already been typed by the player as shifted down into the next line, as compared with the character string 23B before typing.

Furthermore, the song state display section 25 is a section which displays in which verse is the phrase of the lyrics which is currently being displayed on the lyrics display section 22 and the Alphabet letters display section 23, and moreover to which number phrase it corresponds, counting from when the verse started. Here, the typing game according to this embodiment consists of a plurality of stages (for example, it may consist of first through third stages) corresponding to the number of verses in the song which is reproduced (for example, one song may be made up from 1 to 3 verses). For example, in FIG. 3B, it is shown that the fifteenth phrase of stage 1 (i.e. of verse 1) is currently being displayed. Furthermore, in FIG. 4B, it is shown that the fifth phrase of stage 2 (i.e. of verse 2) is currently being displayed.

And, each time the input of a single phrase is completed by the player, a numerical value 25A which indicates the number of this phrase is incremented by 1; and, each time the input during a single stage is completed, a numerical value 25B which indicates the stage number (the verse number) of this stage is incremented by 1. By doing this, it becomes possible to notify to the player the stage number (i.e. the verse number) at the present time, and the number of phrases for which typing has been completed up until the present time.

The typing result display section 26 is a display section which displays the results of determination of correctness or incorrectness of the typing by the player, and “PERFECT” is displayed for key input, when the correct characters have been input at the correct timing. Furthermore, “GOOD” is displayed when the correct characters have been input, but there is a deviation in the input timing. On the other hand, “MISS” is displayed when the wrong characters have been typed, irrespective of their timing.

The score display section 27 is a display section which displays the score and the points which have been acquired by the player up till now. Here, the score is added to by the player typing correctly according to the character string which is displayed in the lyrics display section 22 and in the Alphabet letters display section 23. And, moreover, the score is also added to if the corresponding characters have been typed at the same timing as the vocals of the song which is played.

On the other hand, the points are added to one point at a time (S45 of FIG. 14), if the text for one phrase has all been input without making any typing errors.

And this score and these points are added up until the game is completed, and then, when the game ends, if an IC card has been inserted into the card insertion slot 10, this score and these points which have been acquired are stored on that IC card.

Furthermore, the name of the song selected by the player at the start of the game, which is currently being played, and the name of its artist, are both displayed in the song information display section 28.

Moreover, in the main game screen 21 of the first liquid crystal display 3, as shown in FIG. 3B and FIG. 4B, an independent image region 101 is provided at its central upper portion. And the image in this independent image region 101 is displayed at the same timing as that of the image 20 of the PV which is displayed on the second liquid crystal display 4. It should be noted that this independent image region 101 may also be provided within the main game screen 21 as superimposed over the lyrics display section 22, the Alphabet letters display section 23, the song state display section 25, the typing result display section 26, the score display section 27, and the song information display section 28.

It should be understood that, as shown in FIG. 3A and FIG. 4A, an artist name information display section 24 is provided at the upper left edge portion of the second liquid crystal display 4, on which the PV image 20 is displayed. In this artist name information display section 24, the name of the artist who is currently performing on the PV image 20 is displayed. And, at the lower right edge portion of the second liquid crystal display 4, there is provided a song name information display section 29. In this song name information display section 29, the name of the song which is currently being performed in the PV image 20 is displayed.

Moreover, as shown in FIG. 3B and FIG. 4B, on the first liquid crystal display 3 as well, in the independent image region 101 of the main game screen 21, the name of the artist and the name of the song are displayed at its upper left edge, and at its lower right edge, respectively.

At the upper edge portion and the lower edge portion of the independent image region 101, other than the name of the artist and the name of the song, it would also be acceptable to display the number of phrases in the song which is currently being performed, or the number of this stage (i.e. of this verse), or the score or the points or the like which the player has acquired up to the present; or, conversely, it would also be acceptable not to display anything at all.

Furthermore although, in this embodiment, it is arranged to display the main game screen 21 on the first liquid crystal display 3, and to display the PV image 20 on the second liquid crystal display 4, conversely, it would also be acceptable to display the PV image 20 on the first liquid crystal display 3, and to display the main game screen 21 on the second liquid crystal display 4.

And, in this case, the independent image region 101 would be provided at the central upper portion of the main game screen 21 which is displayed on the second liquid crystal display 4, and the PV image 20 which is displayed on the first liquid crystal display 3 at the same timing would be displayed in this independent image region 101.

And, after the typing game has been completed, as shown in FIG. 5, a game result screen 30 which shows the game result of the typing game this time is displayed on the first liquid crystal display 3.

This game result screen 30 consists of an error number display section 31 on which the number of errors typed during the current typing game is displayed, an acquired point display section 32 on which the number of points acquired is displayed, an acquired score display section 33 on which the score acquired is displayed, and a name input display section 34 which invites input of the name of the player who has been playing.

And, by referring to this game result screen 30, the player is able to recognize each of the number of errors in the current typing game, the points which he has acquired, and the score which he has acquired. Furthermore, by inputting any desired name into the name input display section 34 by using the keyboard 6, he is able to record the score which he has acquired in a ranking list. It should be understood that a list of the rankings which have been recorded is displayed on the first liquid crystal display 3 or the second liquid crystal display 4 during a demo screen or the like.

It should be understood that it would also be acceptable, while the game result screen 30 is being displayed on the first liquid crystal display 3, to arrange to display, on the second liquid crystal display 4, the lyrics of the song which is used for the game in a flowing manner, and moreover, optionally, to show spots at which the player is not able to perform typing input correctly by margin lines or the like; and it would be acceptable to display these lyrics so that they scrolled from the bottom in the upwards direction; or, alternatively, it would also be acceptable to arrange to play a PV of any desired song. Furthermore, it would also be acceptable to display the image of an advertisement, or the like. Moreover, it would also be acceptable to arrange to display the game result screen 30, not on the first liquid crystal display 3, but on the second liquid crystal display 4.

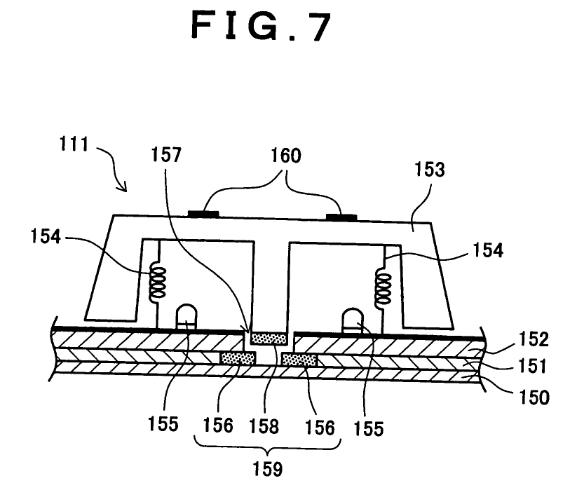

Next, the keyboard 6 which is provided to this typing game apparatus 1 will be explained with reference to FIG. 6 and FIG. 7. FIG. 6 is a plan view showing the keyboard which is provided to the typing game apparatus according to this embodiment. And FIG. 7 is a schematic sectional view showing, in cross section, one of a plurality of keys which are provided to this keyboard.

As shown in FIG. 6, the keyboard 6 is a Japanese 108 key keyboard on which there are arrayed a plurality of character input keys 111 which perform input of Alphabet letters (A through Z), Japanese kanas (“a” through “n”), digits (0 through 9), punctuation symbols (period and comma) and the like, and various function keys 115 such as an enter key 112, a shift key 113, cursor keys 114, a backspace key 116, and the like.

And, during play, the player progresses through the game by performing character input by inputting the character input keys 111 corresponding to characters, punctuation marks, digits and the like. On the other hand, before the start of play and after the end of play and the like, based on operation of the function keys 115, he issues commands to determine on the songs with which to perform the game, to perform selection determination of the game difficulty level, to start the execution of the game, and the like. Furthermore, as will be described hereinafter, illumination LEDS are provided in the interiors of various keys on the keyboard 6, so that, based on control signals from the CPU 51, the keys may be illuminated in various ways.

Now, the structure of the interiors of the keys of the keyboard 6 will be explained based on FIG. 7. It should be understood that all of the plurality of keys which are arranged on the keyboard 6 have similar interior structures. Accordingly, in the following, the interior construction of one of the character input keys 111 among the plurality of keys which are arranged on the keyboard 6 will be explained by way of example, and explanation of the structure of the other character input keys 111, and of the function keys 115, will be curtailed.

As shown in FIG. 7, this character input key 111 fundamentally comprises a base plate 150, a switch circuit board 151, a illumination circuit board 152, a keytop 153, biasing mechanisms 154, full color LEDs 155, and the like.

In particular, on the switch circuit board 151 which is laid over the base plate 150, there are provided a pair of electrodes 156 which are disposed directly underneath the vicinity of the center of the keytop 153.

Furthermore, an opening portion 157 for exposing the above described pair of electrodes 156 is provided on the illumination circuit board 152 which is laid over the switch circuit board 151, and full color LEDs 155, which can be illuminated in full color, are provided around the circumference of this opening portion 157.

Moreover, the biasing mechanisms 154 are provided between the illumination circuit board 152 and the keytop 153, and the keytop 153 is biased to the opposite side of the switch circuit board 151 by these biasing mechanisms 154. Furthermore, an electrode 158 is provided in the vicinity of the center of the keytop 153, so as to project towards the switch circuit board 151.

Accordingly since, when the keytop 153 is actuated by being pressed downwards, the electrode 158 which is provided so as to project from the keytop 153 is able to contact against the pair of electrodes 156 which are provided on the switch circuit board 151, therefore the fact that the keytop 153 has been actuated by being depressed can be transmitted as an electrical signal which flows in the switch circuit board 151. In other words, a key switch 159 is constituted by these three electrodes 156 and 158.

It should be understood that the biasing mechanisms 154 may be made as simple elastic bodies, or may be made as elastic bodies with linking mechanisms; they may be of any appropriate structure.

Furthermore, the keytop 153 may be made from any material which has the property of being translucent to light (for example, from translucent acrylic or translucent plastic or the like), and key information 160 such as a character, a digit, a symbol or the like may be printed on its planar top surface in black color. Moreover, the surface of the illumination circuit board 152 facing towards the keytop 153 may also be printed in black color.

Accordingly, while the full color LEDs 155 are turned off, the translucent keytop 153 appears in black color, which is the color of the surface of the illumination circuit board 152, so that it becomes difficult to recognize the key information 160 which is printed in black color, against this keytop 153 which appears in the same black color.

On the other hand since, when the full color LEDs 155 are turned on, the translucent keytop 153 appears in the color in which the full color LEDs 155 are illuminated, accordingly it becomes easy to recognize the key information 160 which is printed in black color, on this keytop 153 which appears in color.

And, in the keyboard 6, the various key switches 159 in the interiors of the keys are connected to a signal generation circuit not shown in the figures. This signal generation circuit is connected to the CPU 51 of the typing game apparatus 1 via an interface unit 52 (subsequently termed an I/O) which will be described hereinafter. Accordingly, by transmitting an electrical signal from the key switch 159 of a key which has been operated by being pressed via this signal generation circuit to the CPU 51, it is possible to specify the type of the key which has been operated by being pressed. It should be understood that this signal generation circuit is mounted on the above described switch circuit board 151.

Furthermore, in the keyboard 6, the full color LEDs 155 interior to the keys are connected to an illumination control circuit 62. Moreover, the illumination control circuit 62 is connected via the I/O 52 to the CPU 51 (refer to FIG. 9). Accordingly, via this illumination control circuit 62, it is possible to turn these full color LEDs 155 interior to the keys on according to the colors which have been specified by the CPU 51.

In concrete terms, with this typing game apparatus 1 according to this embodiment, during the typing game, if it has been determined that key input has occurred, and moreover that correct typing has been performed, then the character input key 111 which has been depressed is illuminated in blue color. Furthermore, if it has been determined that key input has occurred, but that incorrect typing has been performed, then the character input key 111 which has been depressed is illuminated in red color, while the correct key which should have been input is illuminated in green color. Moreover, if no key input has taken place, then only the correct key which should have been input is illuminated in green color.

It should be understood that, as shown in FIG. 8, the typing game apparatus 1 according to this embodiment is connected to a server 80 via a network N, such as the internet or the like, which is capable of bi-directional communication. And, based on data transmitted from the server 80, the music data stored on the HDD 55 (refer to FIG. 9) of the typing game apparatus 1 can be updated.

Accordingly it is made possible, by updating the music data, to change the type of songs which can be played on the typing game apparatus 1, and furthermore, by managing several typing game apparatuses which are set up in several game arcades all together, this data updating task becomes simple and easy.

Next, structures related to the control system for this typing game apparatus 1 will be explained based on FIG. 9. FIG. 9 is a schematic block diagram showing the control system for the typing game apparatus according to this embodiment.

As shown in FIG. 9, the control system for the typing game apparatus 1 comprises a CPU 51 which oversees the various types of control for the typing game apparatus 1 such as play processing operation and the like, a ROM 53 and a RAM 54 which are connected to the CPU 51, and peripheral devices (actuators) which are electrically connected to this CPU 51 and the like.

The CPU 51 is a central calculation processing device which performs calculation processing according to various types of commands. The I/O 52 is a connection unit which directly and/or indirectly electrically connects the first liquid crystal display 3, the second liquid crystal display 4, the keyboard 6, the illumination devices 7, the speakers 8, the spotlights 11, and so on with the CPU 51.

The ROM 53 is a dedicated non-volatile read out only memory, in which is stored a calculation program for the operation of a flow chart which will be described hereinafter.

Furthermore, the RAM 54 is a memory which temporarily stores various types of data which have been calculated by the CPU 51, and it stores the number of typing errors made by the player during the typing game, the score which he has acquired, the points which he has acquired, and so on. Furthermore, the lyrics data of that music data which, among the plurality of music data stored on the HDD 55 which will be described hereinafter, are used in the current typing game, are temporarily stored in the RAM 54, divided up into single phrases.

The HDD 55 is a storage device on which are stored music data used during the execution of the typing game by the typing game apparatus 1. Here, the music data consists of image data, musical accompaniment data, voice data, lyrics data, determination standard data, pattern data for illumination device illumination, pattern data for keyboard illumination, and time limit data, and these are stored in individual storage regions of a music data storage region 56 which is formed on the HDD 55 (refer to FIG. 10).

Yet further, in the music data storage region 56, there are stored the data for a plurality of songs (in this embodiment, for a maximum of eight songs), and these music data items which are stored are updated whenever required, based on data transmitted from the server 80 as described above. And the types of song names displayed on the song selection screen 15 (refer to FIG. 2) change based on the types of music data stored in the music data storage region 56, and the typing game is performed based on the music data corresponding to the song which has been selected on the song selection screen 15 (refer to FIG. 3 and FIG. 4).

Now, the music data storage region 56 formed on the HDD 55 will be explained in detail with reference to FIG. 10. FIG. 10 is a schematic explanatory figure showing this music data storage region 56.

As shown in FIG. 10, the music data storage region 56 of the typing game apparatus 1 according to this embodiment comprises a plurality of storage regions (in this embodiment, a first through an eighth storage region) which correspond to the number of items of music data which can be stored (in this embodiment, eight songs); and, in each of these storage regions, there are provided an image data storage region 56A, a musical accompaniment data storage region 56B, a voice data storage region 56C, a lyrics data storage region 56D, a determination standard data storage region 56E, an LED illumination pattern data storage region 56F, a keyboard illumination pattern data storage region 56G, and a time limit data storage region 56H.

Now, each of these data storage regions which make up the storage regions comprised in the music data storage region 56 will be explained. The image data storage region 56A is a storage region in which are stored image data, among this music data, related to the PV image 20 (refer to FIG. 3A and FIG. 4A). Accordingly, when executing the typing game, image data related to the PV image 20 is read out from the image data storage region 56A, and is displayed in the independent image region 101 of the first liquid crystal display 3 and on the second liquid crystal display 4 at the same timing.

Moreover, the musical accompaniment data storage region 56B is a storage region in which are stored musical accompaniment data, among the music data, related to accompaniment by musical instruments, and output from the speakers 8.

Furthermore, the voice data storage region 56C is a storage region in which are stored voice data, among the music data, related to the singing voice of the artist who is singing, and output from the speakers 8.

Moreover, the lyrics data storage region 56D is a storage region in which are stored lyrics data, among the music data, related to the text data of the lyrics of the song. And, as described above, during the execution of the typing game, these lyrics of the song are sequentially read out from the lyrics data storage region 56D and displayed on the first liquid crystal display 3 one phrase at a time (refer to FIG. 3B and FIG. 4B).

And the determination standard data storage region 56E is a storage region in which are stored determination standard data, among the music data, which are read out, during the execution of the typing game, as a standard for determining the correctness of the characters which the player has typed, and the correctness of his input timing. And the CPU 51 adds to the number of errors, the score, the points and so on, based on this stored determination standard data and on the operation signals from the keyboard 6, as will be described hereinafter.

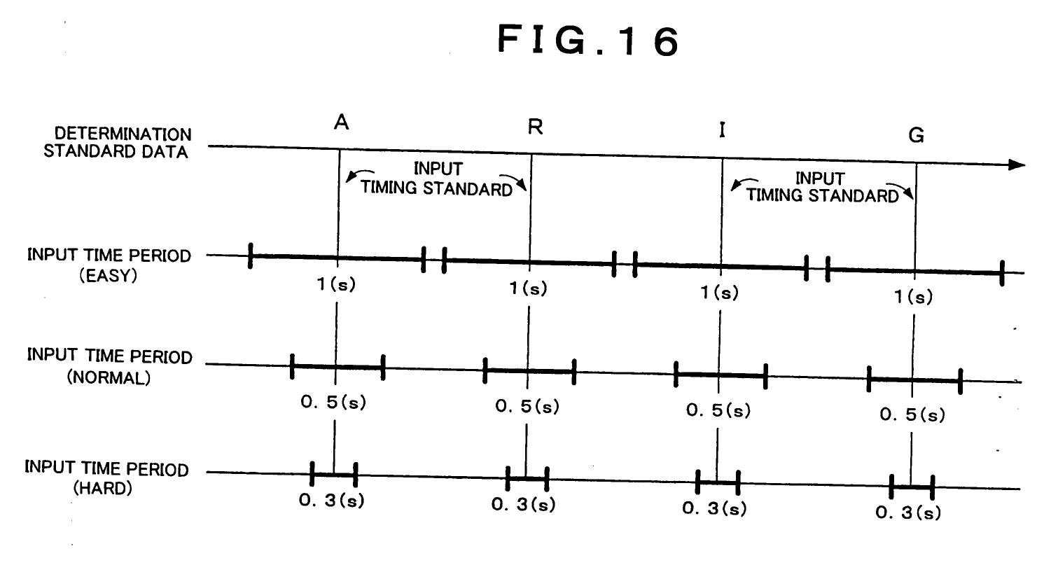

This determination standard data is determined for the lyrics of the song, and comprises (refer to FIG. 16) key input determination standard data for determining whether key input is correct or not, and input timing determination standard data which is based on the singing of the song by the singer, and which is determined for each key which must be input. In other words, this key input determination standard data is data by which the correct key is stipulated for each single one of the characters which make up the lyrics of song. And this input timing determination standard data is data by which the elapsed time from when the playing of the song started is stipulated, for each single one of the characters which make up the lyrics of song.

Thus the input timing stipulates the elapsed time from when the playing of the song started, for each single one of the characters which make up the lyrics of song. If, for example, “a” is sung at the time point “133 seconds” from when the playing of the song started, then “133 seconds” is the input timing for the character input key 111 of “A”.

As will be explained hereinafter in detail, it should be understood that, with the difficulty level settings of “EASY MODE”, “NORMAL MODE”, and “HARD MODE” which are set with the above described difficulty level selection screen 12, the input timings which are stipulated by the determination standard data are determined as a standard, and the difficulty level of the typing game is changed by changing the length of the input time periods, during which it is determined that the timing of key inputs is correct. In other words, if this input time period is long, it is determined that the input timing is correct even if it has deviated more or less, so that even a player who is a novice at the typing game may derive a sufficient amount of pleasure from playing the game. On the other hand, if this input time period is short, then, since it is necessary to input the corresponding key within this input time period, accordingly it is possible to provide a typing game which is aimed at a typist of a high standard who has requested this high level typing technique.

Yet further, the LED illumination pattern data storage region 56F and the keyboard illumination pattern data storage region 56G are storage regions in which are respectively stored, among the music data, pattern data for illumination device illumination for illuminating the illumination devices 7, and pattern data for keyboard illumination for illuminating the full color LEDs 155 which are provided in the interiors of the keys.

With the typing game apparatus 1 according to this embodiment, during the execution of the typing game, the pair of illumination devices 7 are controlled to respective illumination states (an illumination color, and whether it is turned on or off) by an illumination control circuit 62, based on the pattern data for illumination device illumination which is stored. This illumination state (an illumination color, and whether it is turned on or off) will be described hereinafter.

Furthermore, during the execution of the typing game, the state of illumination of each of the full color LEDs 155 provided in the interiors of the keys is controlled to a respective illumination state (an illumination color, and whether it is turned on or off) by the illumination control circuit 62, based on the stored pattern data for keyboard illumination.

It should be understood that, as illumination patterns for the full color LEDs 155, there may be utilized a pattern of illumination which assists key input for a novice at the typing game by turning on in order the keys which must be input with illumination colors which are different from the illumination color of the keyboard 6 as a whole, or a pattern in which the illumination colors of all of the keys which are disposed on the keyboard 6 are varied along with the image for the song.

Still further, the time limit data storage region 56H is a storage region in which are stored, among the music data, time limit data related to a time limit over which the music data may be used; this time limit data comprises two items of date data: a day when the music data becomes usable (a usage start day); and a day when the music data becomes unusable (a usage end day). This time limit data is utilized along with a timer 58 (refer to FIG. 9) in the management of time limits for use of the music data; and the typing game is controlled by the CPU 51 so that the typing game cannot be played using music data whose time limit for use has been exceeded.

Now, returning to FIG. 9, the explanation of the control system of the typing game apparatus 1 will be continued.

A game communication unit 57 is a device which, along with converting a signal which is output by the typing game apparatus 1 into a signal of a format which can be transmitted according to a communication method such as a telephone line or a LAN cable or the like, and transmitting it to the server 80, also receives a signal which has been transmitted from the server 80, and re-converts it into a signal of a format capable of being read in by the typing game apparatus 1. And this game communication unit 57 is connected to a server communication unit 81 of the server 80 via the network N, such as the internet or the like, which is capable of bi-directional communication (refer to FIG. 8).

Moreover, a timer 58 is connected to the CPU 51. The information from this timer 58 is transmitted to the CPU 51, and the CPU 51 performs management of the usage time limits for music data which has been stored, from the information of the timer 58 and from the time limit data which is stored in the time limit data storage region 56H of the HDD 55.

Furthermore, a display control circuit 60 is a section which is connected via the I/O 52 to the CPU 51, and which controls the display contents of the first liquid crystal display 3 and the second liquid crystal display 4 according to the results of calculation processing by the CPU 51. Here, this display control circuit 60 comprises a program ROM, an image ROM, an image control CPU, a work RAM, a VDP (Video Display Processor), a video RAM, and the like.

And, in the program ROM, there are stored a program for image control and various types of selection table related to display on the first liquid crystal 3 and the second liquid crystal display 4. In particular, there are stored a program for image control which is required when providing the independent image region 101 on the first liquid crystal display 3, and in order to display the PV image 20 within this independent image region 101 and on the second liquid crystal display 4 at the same timing, and various types of selection tables.

Furthermore, there are stored in the image ROM, for example, dot data for forming images which are displayed on the first liquid crystal display 3, such as, for example, the song selection screen 15 (refer to FIG. 2), the main game screen 21 (refer to FIGS. 3 and 4), and so on.

And the image control CPU performs determination, from among the dot data which has been stored in advance in the image ROM, of the images to display on the first liquid crystal display 3 and on the second liquid crystal display 4, according to an image control program which has been stored in advance in the program ROM, based on parameters which have been set by the CPU 51. Moreover, the VDP forms images according to the display contents which have been determined by the image control CPU, and outputs them to the first liquid crystal display 3 and to the second liquid crystal display 4.

By doing this, for example, during the standby state, a demo screen which consists of a PV for any desired song, an advertisement, a list of rankings or the like may be displayed, and furthermore, after a coin has been inserted into the coin insertion slot 9, the song selection screen 15 (refer to FIG. 2) is displayed on the first liquid crystal display 3.

And, when the execution of the typing game on the typing game apparatus 1 is started, the lyrics data included in the music data is displayed one phrase at a time on the first liquid crystal display 3, while control is performed based on the input results from the keyboard 6, for comparing the character string 23A which has already been typed by the player with the character string 23B before typing and shifting it downward.

On the other hand, the PV, which is image data included in the music data, is displayed on the second liquid crystal display 4. And, moreover, the independent image region 101 is provided at the upper central portion of the main game screen 21 on the first liquid crystal display 3, and this PV is displayed at the same timing both in this independent image region 101 and on the second liquid crystal display 4.

A sound control circuit 61, along with being connected via the I/O 52 to the CPU 51, is also connected to the speakers 8. And, when the typing game is executed and the music data which has been stored in the music data storage region 56 of the HDD 55 is read out, the musical accompaniment data and the voice data which are included in this music data are converted into a sound signal by this sound control circuit 61, and are output by the speakers 8.

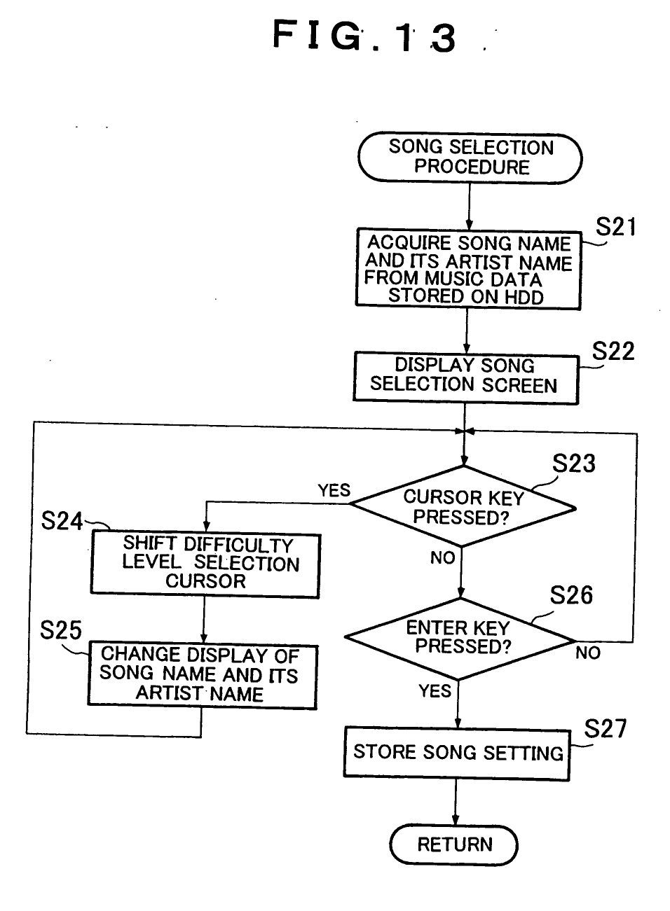

And an illumination control circuit 62, along with being connected via the I/O 52 to the CPU 51, is also connected to the illumination devices 7 and to the full color LEDs 155 (refer to FIG. 7) which are disposed in the interiors of the keys. When the music data which is stored in the music data storage region 56 of the HDD 55 is read out by the CPU 51, this illumination control circuit 62, along with controlling the illumination states of the full color LEDs 155 based on the pattern data for keyboard illumination which are included in this music data, also controls the illumination states of the illumination devices 7, based, not only on the pattern data for illumination device illumination which are included in this music data, but also on the typing game execution processing program (refer to FIG. 13) which will be described hereinafter, and the like.

Returning to FIG. 9, the keyboard 6 is connected to the CPU 51. When the keytops 153 are actuated by being pressed down, the key switches 159 which are provided in the interiors of the keys of the keyboard 6 transmit electrical signals which pass through the switch circuit board 151. The CPU 51 controls the various types of operation which are to be executed corresponding to the various keys, based on the switch signals which are output from the various key switches 159 due to the various keys being pressed down.

A coin sensor 63 is a sensor which detects a coin (for example a 100 yen coin) which is used as payment for performing the typing game on this typing game apparatus 1. This coin sensor 63 is provided in the interior of the coin insertion slot 9, and is connected via the I/O 52 to the CPU 51. Accordingly, based on insertion of a coin into the coin insertion slot 9, the coin sensor 63 generates a coin inserted signal and sends it to the CPU 51. And the CPU 51 makes it possible to execute the typing game, when it has detected coin insertion signals corresponding to a predetermined game fee (for example 200 yen).

Moreover, a card sensor 64 is a sensor which detects whether or not an IC card is inserted into the card insertion slot 10, and a card reader-writer 65 is a device for performing reading out and writing in of data to and from an IC tag which is provided on such an IC card. The card sensor 64 and the card reader-writer 65 are both provided in the interior of the card insertion slot 10, and are connected via the I/O 52 to the CPU 51. And, if an IC card has been detected by the card sensor 64, on performance of a predetermined operation, the game result of the typing game is read out from the IC tag by the card reader-writer 65 (S3 of FIG. 11). Moreover, when the typing game has been finished, it performs writing into the IC tag (S10 of FIG. 11) of the new game result (i.e. of the score and the points which have been acquired).

Furthermore, a spotlight control circuit 66, along with being connected to the CPU 51 via the I/O 52, is also connected to the spotlights 11. And, based on commands from the CPU 51, this spotlight control circuit 66 controls the illumination states of the spotlights 11, and, in particular, when the illumination states of the illumination devices 7 are being controlled by the above described illumination control circuit 62 and the like, by emitting light while causing the spotlights 11 to rotate, it makes the illumination effects of the illumination devices 7 more gaudy. Accordingly, in the LED illumination pattern data which is included in the music data stored in the music data storage region 56 of the HDD 55, there is appended contents for controlling the illumination states of the spotlights 11, in order to make the illumination effects of the illumination devices 7 more gaudy. However, these contents for controlling the illumination states of the spotlights 11 may also be provided separately from the LED illumination pattern data.

And a control timer 59 which can perform measuring time in units of 1/10 second is connected to the CPU 51. This control timer 59 is a timing device which is used when executing various types of control program which will be described hereinafter. In particular, in this embodiment, timing by this control timer 59 is started along with the execution of the typing game being started, and it is referred to when determining the correctness of the input timing during the typing game.

Next, a main processing program which is performed by this typing game apparatus 1 structured as above will be explained with reference to the figures. FIG. 11 is a flow chart showing the main processing program of the typing game apparatus 1 according to this embodiment.

It should be understood that each of the programs comprised in the typing game apparatus 1 and shown in the flow charts of FIGS. 11 through 13 below is stored in the ROM 53 or the RAM 54 which is provided to the typing game apparatus 1, and is executed by the CPU 51.

As shown in FIG. 11, first, in a step S1, based on the detection signal from the card senor 64, the CPU 51 determines whether or not an IC card is inserted into the card insertion slot 10.

And, if it has determined that an IC card is inserted (S1: YES), then in a step S2 it is further determined whether or not a check request from the player for the data contents has been received. On the other hand, if it has been determined that no IC card is inserted (S1: NO), then the flow of control proceeds to a step S4.

Thus, with the typing game apparatus 1 according to this embodiment, when the shift key 113 on the keyboard 6 is pressed down in the state before insertion of a coin and also with an IC card possessed by the player having been inserted into the card insertion slot 10, a list of the game results which have been recorded on the IC card is displayed on the first liquid crystal display 3. By doing this, it becomes possible for the player to check the history of his own game results.

Accordingly, in the determination of the step S2, it is determined, based on the operation signal from the keyboard 6, whether or not the shift key 113 has been pressed down. If it has been determined that the shift key 113 has been pressed down (S2: YES), then the data on the IC tag which is mounted on the IC card is read out by the card reader-writer 65, and, based on this read out data, a list of game results is displayed (in a step S3) on the first liquid crystal display 3.

Furthermore, in the step S4, a starting acceptance procedure is performed. In concrete terms, in this starting acceptance procedure, it is determined whether or not coins (100 yen coins or the like) have been inserted into the coin insertion slot 9 to a predetermined monetary amount (in this embodiment, to the amount of 200 yen). And the system waits in a standby state, while displaying a demo screen or the like consisting of a demo play game screen, a PV of some desired song, an advertisement, a list of ranking data, or the like on the display, until such a number of coins are thus inserted.

It should be understood that, with the typing game apparatus 1 according to this embodiment, when a coin is inserted into the coin insertion slot 9, it is detected by the coin sensor 63, which outputs a coin detection signal to the CPU 51. Due to this, it is possible for the CPU 51 to determine that a coin has been inserted by the player.

And when coins to the predetermined monetary amount are inserted, and after the starting acceptance procedure (in the step S4) has terminated, the flow of control proceeds to the difficulty level selection procedure of the step S5.

In this difficulty level selection procedure of the step S5, a procedure is performed for setting the difficulty level of the typing game which will be executed this time. In other words, the difficulty level selection screen 12 is displayed on the first liquid crystal display 3, and a procedure is performed for the player to select the setting which he desires, from the above described settings “EASY MODE”, “NORMAL MODE”, and “HARD MODE”. By doing this, the player is able himself to select play of the typing game at the difficulty level which will afford him the most pleasure. The difficulty level setting data which indicates the difficulty level selected during this difficulty level selection procedure (in the step S5) is stored in the RAM 54, and is used in a correctness determination procedure (in the step S38) during a typing game execution procedure which will be described hereinafter.

It should be understood that this difficulty level selection procedure will be explained in detail hereinafter with reference to the figures, and accordingly its explanation here is omitted.

Next, in a step S6, a song selection procedure is performed for selecting the song which is to be used during the execution of the typing game this time. In this song selection procedure, based on the type of music data which is stored in the music data storage region 56 of the HDD 55 as will be described hereinafter, the song selection screen 15 (refer to FIG. 3) is displayed on the first liquid crystal display 3, and the song which is to be used in the present game is set. This song selection procedure of the step S6 will be explained in detail hereinafter with reference to the figures.

And, when the song which is to be used in the current typing game has been determined by the song selection procedure of the step S6, a typing game execution procedure is performed in a step S7.

In the typing game execution procedure of the step S7, along with playing the song based on the song which is selected in the song selection procedure of the step S6, the score and the points are added up based on the results of typing on the keyboard 6, and this is continued until a predetermined termination condition is satisfied. This typing game execution procedure of the step S7 will be explained in detail hereinafter with reference to the figures.

Thereafter, when the typing game execution procedure of the step S7 has terminated, a game result display procedure is performed (in a step S8).

In this game result display procedure of the step S8, the game result screen 30 (refer to FIG. 5) is displayed on the first liquid crystal display 3, based on the results of the typing game which has actually been performed.

On this game result screen 30, there are displayed the number of errors during the current typing game, the points which have been acquired, and the score which has been acquired, all of which have been stored in the RAM 54, and also a name input display section 34 is displayed, along with an invitation to the player who has played the current game to input his name. Furthermore, if in this state the keyboard 6 is operated, the characters which have been thus input are displayed in the name input display section 34, based on the keyboard operation signals. And, if the score which the player has acquired is greater than a predetermined score, then ranking data which is stored in the RAM 54 is updated. After this game result display procedure of the step S8 has terminated, the flow of control proceeds to a step S9.

Next, in the step S9, the CPU 51 determines whether or not an IC card is inserted into the card insertion slot 10, based on the detection signal from the card sensor 64. And, if it has been determined that an IC card is thus inserted (S9: YES), then the points which have been acquired during this typing game and the score which has been acquired during this typing game, which are stored in the RAM 54, are both written by the card reader-writer 65 into the IC tag which is mounted on the IC card. It should be understood that the data which are written here may be referred to by the data contents display procedure of the step S3 when the typing game is played the next time.

On the other hand, if it has been determined that an IC card is not inserted (S9: NO), then this procedure terminates.

Now the various procedures which make up the main control program will be explained in detail with reference to the figures.

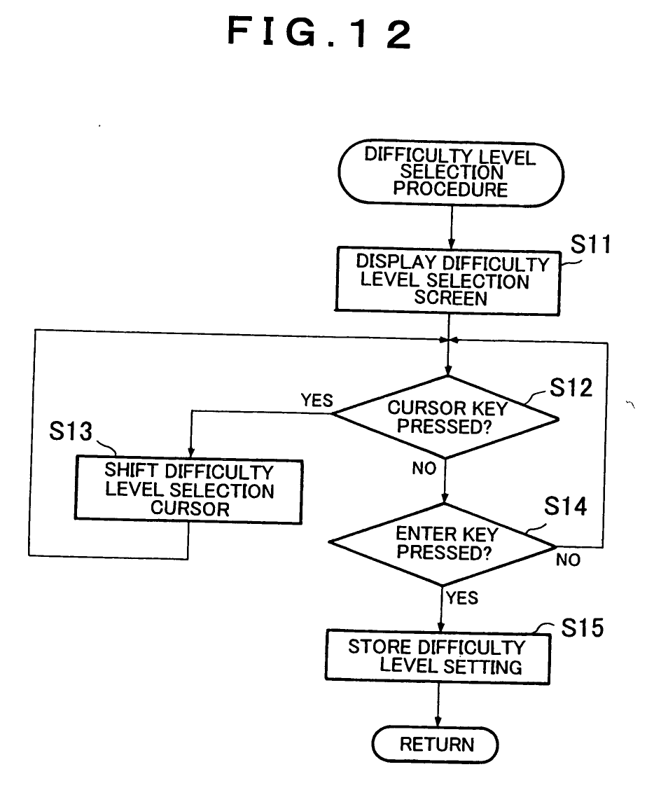

First, the difficulty level selection procedure of the step S5 will be explained with reference to FIG. 12. FIG. 12 is a flow chart showing a difficulty level selection program.

When the flow of control proceeds to this difficulty level selection procedure (of the step S5), first, the CPU 51 displays the difficulty level selection screen 12 (refer to FIG. 2A) on the first liquid crystal display 3 (in a step S11).

Accordingly, the difficulty level display sections 13 which show the three difficulty level settings of “EASY MODE”, “NORMAL MODE”, and “HARD MODE”, and the difficulty level selection cursor 14 which indicates the difficulty level display section 13 which is selected by the player, are displayed on the first liquid crystal display 3.

And, in a step S12, the CPU 51 performs a determination as to whether or not a cursor key 114 has been input. Here, the CPU 51 determines whether or not input of a cursor key 114 has occurred, based on the operation signals for the cursor keys 114 which are transmitted from the keyboard 6. If a cursor key 114 has been input (S12: YES), then the difficulty level selection cursor 14 is shifted (in a step S13) based on which one of the cursor keys 114 has been actuated (i.e. which of the up or down keys has been pressed), and then the flow of control returns to the step S12. On the other hand, if no cursor key 114 has been input (S12: NO), then the flow of control proceeds to a step S14.

It should be understood that although, as shown in FIG. 6, on the keyboard 6 according to this embodiment, there are provided four cursor keys 114 for the upwards, downwards, leftwards, and rightwards directions, nevertheless, in this difficulty level selection procedure of the step S5, any input from the cursor keys 114 for the leftwards and rightwards directions is ineffective.

In the step S14, the CPU 51 determines whether or not the enter key 112 has been input. Here, if the enter key 112 has been input (S14: YES), then the difficulty level of the current typing game is determined based on the difficulty level setting which corresponds to that one of the difficulty level display sections 13 over which the difficulty level selection cursor 14 is currently positioned. And the difficulty level setting which has been thus determined is stored in the RAM 54 (in a step S15) as the difficulty level setting data. After this difficulty level setting data has been stored in the RAM 54, this difficulty level selection procedure of the step S5 terminates.

On the other hand, if it has been determined that the enter key 112 has not been pressed either (S14: NO), then the flow of control again returns to the determination procedure of the step S12.

Next, a song selection processing program which is executed, in the main control program, during the song selection procedure of the step S6 will be explained with reference to the figures. FIG. 13 is a flow chart showing the song selection processing program according to this embodiment.

In the song selection procedure of the step S6, first, the CPU 51 acquires (in a step S21), from the music data storage region 56 of the HDD 55, the song names of the stored music data and their artist names (in this embodiment, a maximum of eight such data items).

And the song selection screen 15 (refer to FIG. 2B) is displayed (in a step S22) on the first liquid crystal display 3, based on the song names and their artist names which are acquired in the step S21.

On this song selection screen 15, the song names which have been acquired are displayed as a list in the playable song name display sections 16, and moreover, in the selected song name display section 18 and the selected artist name display section 19, there are respectively displayed the the song name and its artist name which are selected with the song selection cursor 17.

Next, in a step S23, the CPU makes a determination as to whether or not a cursor key 114 has been input. Here, it is determined whether or not input of a cursor key 114 has occurred, based on the operation signals which are transmitted from the keyboard 6.

If it has been determined that a cursor key 114 has been pressed down (S23: YES), then, based on the operation of the cursor keys 114 (i.e. on which of the up key and the down key has been pressed), the song selection cursor 17 which is displayed on the first liquid crystal display 3 is shifted (in a step S24) in this direction for which a corresponding cursor key 114 was pressed.

Furthermore, in a step S25, the displays in the selected song name display section 18 and the selected artist name display section 19 are changed to the song name which corresponds to the song which has newly been selected by the song selection cursor 17 which was shifted in the previous step S24, and to the name of its artist. After this, the flow of control returns to the determination procedure of the step S23.

On the other hand, if in the step S23 it has been determined that no cursor key 114 has been pressed down (S23: NO), then next in a step S26 it is determined whether or not the enter key 112 has been pressed down. And, if it has been determined that the enter key 112 has been pressed down (S26: YES), then the song at which the current song selection cursor 17 is positioned is set as the song for which the typing game will be performed this time, and the song selection result is stored in the RAM 54 (in a step S27). When the selection of the song which is to be used during the current typing game has thus been determined, this song selection procedure of the step S6 is completed, and the flow of control returns to the main control program.

On the other hand, if it has been determined that the enter key 112 has not been pressed down (S26: NO), then the flow of control again returns to the determination procedure of the step S23.

Next, the typing game execution processing program which is executed by the typing game execution procedure (of the step S7) in the main control program will be explained in detail with reference to the figures. FIG. 14 is a flow chart showing the typing game execution processing program according to this embodiment.

When the conditions for the current typing game have been determined by the difficulty level selection procedure (of the step S5) and the song selection procedure (of the step S6), the flow of control shifts to the typing game execution procedure (of the step S7), and the typing game is executed at the difficulty level which has been set, using the song which has been selected.

In this typing game execution procedure (of the step S7), first, in a step S31, the CPU 51 reads out from the RAM 54 the data which indicates the song which is selected by the song selection procedure of the above step S6, and, based on this data, reads out the music data which corresponds to the result selected by the song selection procedure (of the step S6) from among the music data which is stored in the storage regions (refer to FIG. 10) of the music data storage region 56 on the HDD 55. At this time; the lyrics data which is stored in the lyrics data storage region 56D is temporarily stored in the RAM 54, divided up into single phrases.

Furthermore, in a step S31, the difficulty level setting data which is selected by the difficulty level selection procedure (of the step S5) and stored in the RAM 54 is read out. This read out difficulty level setting data is used in the correctness determination procedure (of the step S38) which performs correctness determination for the keystrokes input by the player.

Next, in a step S32, the main game screen 21 (refer to FIG. 3B and FIG. 4B) is displayed by the CPU 51 on the first liquid crystal display 3. At this time, the independent image region 101 is created in the upper middle portion of this main game screen 21 on the first liquid crystal display 3.

It should be understood that, at this time point, character strings are not displayed in the lyrics display section 22 and in the Alphabet letters display section 23 of the main game screen 21, and also the displays of the score and the points in the score display section 27 are both “0”. Moreover, at this time point, no PV image 20 is displayed in the independent image region 101.

Next, in a step S33, based on the image data which is stored in the image data storage region 56A and which is read out, the CPU 51 starts display of an image 20 of a PV related to the song which has been selected, at the same time, both in the independent image region 101 of the first liquid crystal display 3 and on the second liquid crystal display 4 (refer to FIG. 3A and FIG. 4A).

Furthermore, via the speakers 8, output is performed both of the accompanying music, based on the musical accompaniment data which is stored in the musical accompaniment data storage region 56B, and of the voice, based on the voice data which is stored in the voice data storage region 56C. By doing this, the song is performed, and moreover the image 20 of the PV is reproduced along therewith.

Next, in a step S34, the CPU 51 acquires the lyrics of one phrase of the lyrics data which is stored in the RAM 54, and displays a corresponding character string in the lyrics display section 22 and the Alphabet letters display section 23 of the main game screen 21, with a tempo matching that at which the song is being performed. By doing this, a display of the main game screen 21 is performed on the first liquid crystal display 3 (refer to FIG. 3B and FIG. 4B), in parallel with the performance of the song and with the display of the PV image 20 on the second liquid crystal display 4.

Thereafter, based on the one phrase of lyrics data which has been acquired, the CPU 51 calculates the number of characters n in this single phrase (in a step S35), and writes 0 into a variable m which is stored in the RAM 54 (in a step S36). Here, this variable m is a variable which is used in the input determination of characters corresponding to the characters which make up the single phrase, and it is incremented by 1 (in a step S43) each time the input determination for one character is completed. Accordingly, in the input determination procedure which is repeatedly performed in the following steps S37 through S44, when m=t (where 0≦t≦n−1), input determination comes to be performed for the character which is positioned in the (t+1)-th position from the head of the single phrase.

And, in the step S37, based on the operation signals from the keyboard 6, the CPU 51 makes a determination as to whether or not a key input has been performed with a character input key 111. If it has been determined that a key input has been performed (S37: YES), then input timing data, which indicate the input timing of that key according to the timer 59, are stored in the RAM 54. Thereafter, a correctness determination procedure for the key which has been input is performed (in a step S38), based on the type of the key which has been pressed down, on the input timing data, and on the determination standard data which is stored in the determination standard storage region 56E.

This correctness determination procedure (of the step S38) will be explained in detail hereinafter, and accordingly here it will only be explained in outline.

In concrete terms, in this correctness determination procedure of the step S38, if a key which corresponds to the Alphabet letters displayed in the Alphabet letters display section 23 (refer to FIG. 3B and FIG. 4B) of the main game screen 21 has been input, then it is recognized as having been correctly typed. And, if it has been determined that any key other than this corresponding key has been pressed down, then 1 is added to the number of errors.

Furthermore, if the corresponding key has been input, a determination is then also made as to agreement of the timing of this key input, based on the determination standard data. This timing agreement is determined according to the input timing which is stipulated by the determination standard data, and according to the input time period which is determined based on the difficulty level setting data. If, although the correct key has been input, it has not been input within the input time period, then only the score is added to, based on the fact that the correct key has been input; but, if the correct key has been input within the input time period, then, along with scoring based on the input of the correct key, also the score is added to based on the fact that the key input has been performed at the correct timing.

After having performed the correctness determination for key input, the flow of control proceeds to a step S41.

On the other hand, if it has been determined (S37: NO) that no key input has taken place, then a determination is made (in a step S39), based on information from the control timer 59, as to whether or not a predetermined time period has elapsed (which, when the character at the head of the single phrase is to be input, measures from after the character string which corresponds to the single phrase on the main game screen 21 has been displayed (in the step S34), and which, when some other character is to be input, measures from after the calculation procedure for the score has been performed (in a step S42)). And if it is determined that the predetermined time period has not elapsed (S39: NO), then the flow of control returns to the determination procedure of the step S37.

On the other hand, if it has been determined that the predetermined time period has elapsed (S39: YES), then it is taken that key input by the player has not been performed, and 1 is added (in a step S40) to the number of errors in the current game which is stored in the RAM 54.

Next, in a step S41, a key illumination procedure for the full color LEDs 155 which are provided in the interiors of the keys of the keyboard 6 is performed. In concrete terms, with the typing game apparatus 1 according to this embodiment, if key input has been performed (S37: YES), and if moreover a determination has been made that this key has been correctly typed, then the character input key 111 which has been pressed down is illuminated in blue color. Furthermore if, while key input has been performed (S37: YES), a determination has however been made that this key has been mistakenly typed, then the character input key 111 which has been pressed down is illuminated in red color, while the correct key which should have been pressed down is illuminated in green color. Furthermore, if no key input has taken place (S37: NO), then the correct key which should have been pressed down is illuminated in green color.

Moreover, in a step S42, a procedure for calculating the score is performed, based on the correctness determination procedure of the step S38 described above. In this score calculation procedure (of the step S42), the score of the player for the current game which is stored in the RAM 54 is added to.

In other words, if the result of the determination by the above correctness determination procedure (of the step S38) is that the correct key is input, but that it is not input within the input time period, then the score is only added to based on the fact that the correct key is input; but, on the other hand, if it is determined that the correct key is input within the input time period, then, in addition to the score based on the correct key input, the score is also added to based on the fact that it is input at the correct timing.

Thereafter, in a step S43, the variable m which is stored in the RAM 54 is read out, +1 is added thereto, and it is again stored. Next, in a step S44, a determination is made as to whether or not the value of the variable m has arrived at the value n−1; in other words, it is determined whether or not the character input determinations for the characters which make up the single phrase have all been completed.

And, if it has been determined that the value of the variable m has not arrived at n−1 (S44: NO), then the flow of control returns back to the step S37, and the input determination is performed for the character which is positioned next in order among the characters which make up the single phrase.

On the other hand, if it has been determined that the value of the variable m has arrived at n−1 (S44: YES), then, since the input of all of the characters in the single phrase has been completed, the flow of control is transferred to the step S45.

And, in a step S45, a points addition procedure is performed. In this point addition procedure of the step S45, 1 is added to the points, if it has been determined that all of the n characters which make up the single phrase have been input without making any typing errors (including the determination of a typing error due to lapse of the predetermined time period (S30)). In other words, it is possible to acquire points if the correct keys are input for the n characters which make up the single phrase, without any question as to the correctness or incorrectness of their input timing.

Furthermore, in a step S46, the CPU 51 makes a determination as to whether or not the input determination has been completed for all of the phrases of the stage corresponding to whichever is the current verse, among the plurality of verses which make up the song (normally one song consists of verses 1 to 3). And, if it has been determined (S46: NO) that input determination has not been completed for all of the phrases of one stage, then the flow of control returns to the step S34, and the lyrics of the next phrase are acquired from the RAM 54. By doing this, the character string which corresponds to the lyrics of the next phrase is displayed both in the lyrics display section 22 and also in the Alphabet letters display section 23 of the main game screen 21.

On the other hand, if it has been determined (S46: YES) that the input determination has been completed for all of the phrases for this one stage, then next a determination is made (in a step S47) as to whether or not the input determination has been completed for the phrases of all the stages (i.e. for the entire song).

And, if it has been determined that all of the stages have been completed (S47: YES), then, irrespective of the points currently possessed by the player, this typing game execution procedure is completed, and the flow of control shifts to the main game control program. On the other hand, if it has been determined that all of the stages have not yet been completed (S47: NO), then a determination is made (in a step S48) as to whether or not the number of typing errors by the player up till the present, which has been added up in the correctness determination procedure (of the step S38) or in the step S40, is less than a predetermined number.

With the typing game apparatus 1 according to this embodiment, the game is made up from a plurality of stages which correspond to the number of verses in the song which is reproduced, and, at the time point that one stage has been completed, the condition in order to go on to perform the stage related to the next verse is that the number of typing errors from when playing started is less than a predetermined number (for example, that the number of typing errors is less than 20 when going on to perform the second verse after having played the portion corresponding to the first verse, and that it is less than 35 when going on to perform the third verse after having played the portion corresponding to the second verse).

And, if it has been determined that the number of typing errors by the player up till the present, which has been stored in the RAM 54, is less than the predetermined number (S48: YES), then the flow of control returns to the step S34, and the lyrics which correspond to the first phrase of the next verse of the song are acquired from the RAM 54, and the corresponding character string is displayed on the main game screen 21, in both the lyrics display section 22 and the Alphabet letters display section 23. And the input determination procedure is performed in the same manner. On the other hand, if it has been determined that the number of typing errors by the player up till the present is greater than or equal to the predetermined number (S48: NO), then this typing game execution procedure terminates, and the flow of control shifts to the main control program.

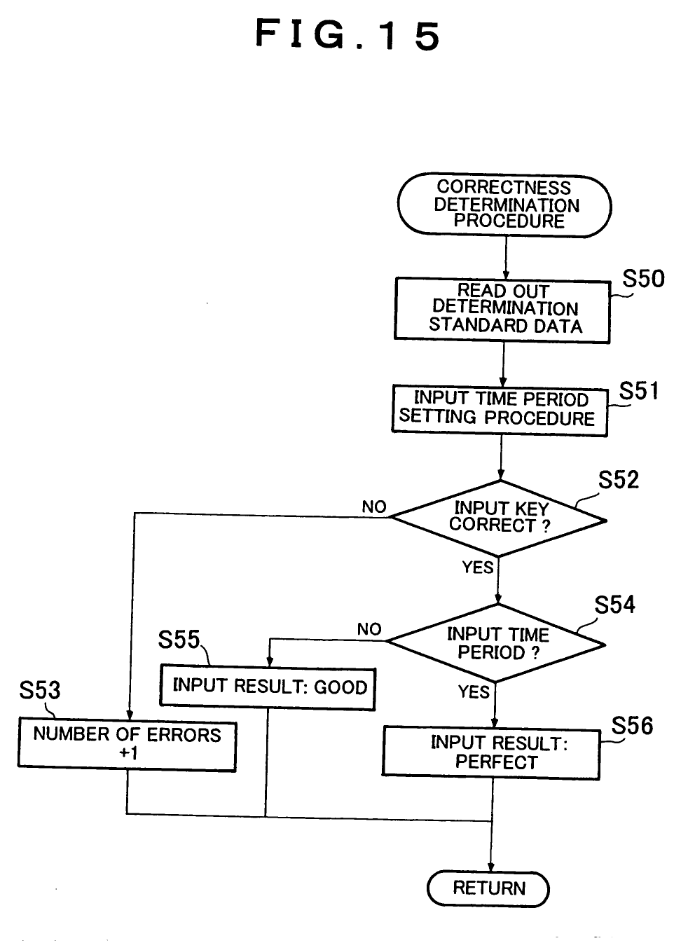

Now, the correctness determination procedure of the step S38 which is performed during the typing game execution procedure of the step S7 will be explained in detail with reference to the figures. FIG. 15 is a flow chart showing the correctness determination processing program. And FIG. 16 is an explanatory figure showing the relationship between the determination standard data, the input time period, and the difficulty level setting.

In the typing game execution procedure, if it is determined that key input has occurred (S37: YES), then the flow of control proceeds to the correctness determination procedure of the step S38, and the CPU 51, first, reads out the determination standard data which is stored in the determination standard data storage region 56E (in a step S50). The determination standard data is determined in correspondence to the lyrics of the song, and it consists of key input determination standard data which determines whether or not the key input is correct, and input timing determination standard data which is determined for each key which must be input, based on the singing of the song by the singer.

And, after the determination standard data has been read out from the determination standard data storage region 56E, an input time period setting procedure is executed (in a step S51).

Now this input time period will be explained in detail with reference to FIG. 16. As explained above, the input time period is a time period from which it is determined whether or not the timing of the key input is correct, and, provided that key input is performed within this input time period, it is determined that this key input has been made at the correct input timing, even if this input has been performed at a timing which does not agree perfectly with the input timing determination standard data. Furthermore, this input time period is obtained by taking as a standard the input timing for each character as stipulated by the input timing determination standard data, and by including a constant time period before and after this input timing.

Thus, the constant time period from which the input time period is set up is determined based on the difficulty level setting data, and it is different according to the difficulty level setting data which has been set.

Accordingly, the input time period setting procedure (in the step S51) is a procedure which sets an input time period according to the difficulty level which has been set, based on the difficulty level setting data which was set by the difficulty level setting procedure in the step S5. As described above, in this embodiment, the three difficulty level settings of “EASY MODE”, “NORMAL MODE”, and “HARD MODE” are available, and the constant time period from which the input time period is set up is different for each of these difficulty level settings. In other words, for example, in the case of “EASY MODE”, since 0.5 seconds is set as being the constant time period before and after the input timing, accordingly the input time period is actually a time period of one second. And, in the case of “NORMAL MODE”, since 0.25 seconds is set as being the constant time period before and after the input timing, accordingly the input time period is actually a time period of 0.5 second. Finally, in the case of “HARD MODE”, since 0.15 seconds is set as being the constant time period before and after the input timing, accordingly the input time period is actually a time period of 0.3 second.

Accordingly, in the input time period setting procedure of the step S51: first the CPU 51 reads out the difficulty level setting data from the RAM 54; then, according to the difficulty level setting which is set, it sets a constant time period before and after the input timing as stipulated by the input timing determination standard data; and then it performs the procedure of setting the input time period.

After this input time period setting procedure of the step S51 has terminated, in a step S52, the CPU 51 makes a decision as to whether or not the key which has been input and the key input determination standard data agree with one another, by referring to the character input key 111 which has been input as specified based on the operation signal from the keyboard 6 and the key input determination standard data which is included in the determination standard data. In other words, a decision is made as to whether or not input of the correct key has been performed.

If input of the correct key has been performed (S52: YES), then the flow of control proceeds to a step S54.

On the other hand, if a key has been input which is different from the key input determination standard data (S52: NO), then, since the key input by the player constitutes a typing mistake, the number of errors in the present typing game, which is stored in the RAM 54, is incremented by 1, and moreover display of “MISS” is performed on the typing result display section 26 (in a step S53).

After thus adding 1 to the number of errors, this value is again stored in the RAM 54, and then the correctness determination procedure of the step S38 terminates.

And, in the step S54, the CPU 51 makes a decision as to whether or not the input time period data, which gives the timing for the key which has been input, is within the input time period which was set by the above input time period setting procedure (of the step S51). If the time given by the input time period data is within the input time period (S54: YES), then, along with a display of “PERFECT” being displayed in the typing result display section 26 of the first liquid crystal display 3, which means that the correct key is input at the correct timing, also data which indicates that the key input result is “PERFECT” is stored in the RAM 54 (in a step S56).

After having displayed “PERFECT” in the typing result display section 26, and having stored the data which indicates the key input result in the RAM 54, the correctness determination procedure of the step S38 terminates, and the flow of control returns to the typing game execution procedure of the step S7.

On the other hand if, although the correct key is input, it is not input within the input time period (S54: NO), then, along with a display of “GOOD” being displayed in the typing result display section 26 of the first liquid crystal display 3, which means that, although the correct key is input, it is not input within the input time period, also data which indicates that the key input result is “GOOD” is stored in the RAM 54 (in the step S55).

After having displayed “GOOD” in the typing result display section 26, and having stored the data which indicates the key input result in the RAM 54, the correctness determination procedure of the step S38 terminates, and the flow of control returns to the typing game execution procedure of the step S7.

Now, the relationship between the correctness determination procedure of the step S38, and the three difficulty level settings of “EASY MODE”, “NORMAL MODE”, and “HARD MODE” will be explained in detail in a more concrete manner with reference to FIG. 16.

To take a concrete example, the case will be considered in detail in which, as shown in FIGS. 4A and 4B, a song (b) which is being sung by a female artist has been selected and the typing game is being executed, and the single phrase “ARIGATOU” is to be input.

In this case, as shown in FIG. 4B, “arigatou”, which is one phrase of the lyrics, is displayed in Japanese kanas in the lyrics display section 22, and this single phrase is displayed in the Alphabet letters display section 23, written in Alphabet letters as “ARIGATOU”.

The determination standard at this time will now be explained with reference to FIG. 16. As described above, this determination standard data consist of key input determination standard data and input timing determination standard data. Accordingly, in the concrete example described above (when the song (b) is used), the correctness determination procedure of the step S38 is executed based on key input determination standard data which indicates the correct order for key input as being . . . “A”, “R”, “I”, “G”, “A”, “T”, “O”, “U”, . . . , and on input timing determination standard data which indicates input timings stipulated for each of the characters of which the lyrics are made up.

The input timing determination standard data are synchronized with the vocal timing for each character as sung by the voice of the artist who is singing. And these input timings are converted into numerical values according to the elapsed time from when playing of the song starts.

In the case of the above described concrete example, as shown in FIG. 16, the input timing for “A” is the time point of “185.0 seconds” from when the playing of the song (b) starts, while the input timing for “R” is the time point of “186.5 seconds” from when the playing of the song starts. In this manner, for each of the characters “I”, “G”, “A”, “T”, “O”, “U”, . . . , the input timing is stipulated according to the time period from when the playing of the song (b) starts.

And, in the correctness determination procedure of the step S38, correctness determination for the keys which are input and correctness determination of the timing of key input are performed based on the above described determination standard data. And, during this correctness determination procedure, in the input time period setting procedure (in the step S51), setting of the input time period in which it is to be determined that the timing of key input is correct, is performed.

Now this input time period setting procedure of the step S51 will be explained in concrete terms, taking the case of the above described concrete example.

As described above, the input time period which is set in the input time period setting procedure of the step S51 is set based on the difficulty level setting data which has been set by the difficulty level setting procedure of the step S5, and it consists of appending a constant time period before and after the input timing which is stipulated by the determination standard data.

Now, the example of the input time period for the input time point for “A”, as shown in FIG. 16, will be explained. In this case, the input timing for “A” is “185.0 seconds”, and, in the case of “EASY MODE”, the constant time period which must be appended is 0.5 seconds before and after this input timing.

Accordingly, the time period of 0.5 seconds before and after the time point of 185.0 seconds (i.e. from 184.5 seconds to 185.5 seconds) becomes the input time period. As a result, by inputting the key “A” during the one second long input time period from 184.5 seconds to 185.5 seconds after the start of the performance of the song (b), the player is able to acquire both a score based on the correct key input, and also a score based on the correct input timing.

And, in the case of “NORMAL MODE”, the constant time period which must be appended before and after the input timing is 0.25 seconds. In this case, the time period of 0.25 seconds before and after the time point of 185.0 seconds (i.e. from 184.75 seconds to 185.25 seconds) becomes the input time period. As a result, by inputting the key “A” during the 0.5 second long input time period from 184.75 seconds to 185.25 seconds after the start of the performance of the song (b), the player is able to acquire both a score based on the correct key input, and also a score based on the correct input timing.

Furthermore, in the case of “HARD MODE”, the constant time period which must be appended before and after the input timing is 0.15 seconds. In this case, the time period of 0.15 seconds before and after the time point of 185.0 seconds (i.e. from 184.85 seconds to 185.15 seconds) becomes the input time period. As a result, by inputting the key “A” during the 0.3 second long input time period from 184.85 seconds to 185.15 seconds after the start of the performance of the song (b), the player is able to acquire both a score based on the correct key input, and also a score based on the correct input timing.

In this manner, the input time period is set by the input time period setting procedure (in the step S51) according to the difficulty level setting data, and the timing for the key input is determined based on the input time period which has been set. In other words, since the input time period is somewhat different according to each of the difficulty level settings of “EASY MODE”, “NORMAL MODE”, and “HARD MODE”, accordingly the widths which are permitted in each case for deviation between the input timing of the player, and the input timing stipulated in the determination standard data, are different.

Accordingly, even in the case of a novice with whom it often happens that he cannot perform correct input during the input time period of “NORMAL MODE”, if he plays in “EASY MODE”, then, since the input time period is set to be wider, the possibility is increased that he will be able to perform correct input during the input time period. As a result, even a novice who is quite weak at the typing game will be able to experience an adequate level of enjoyment when playing the typing game on this typing game apparatus 1.

Furthermore, by a player who is skilled at the typing game and who can consistently perform correct input within the input time period of “NORMAL MODE,” to set the difficulty level setting to “HARD MODE”, he is able to enjoy playing the typing game on this typing game apparatus 1 even more.

In other words, since the input time period is reduced by setting the difficulty level setting to “HARD MODE”, the player is not able to acquire a high score if he does not perform key input at a timing which is approximately the same as the input timing in the determination standard data. Accordingly, the requirement arises for the player to perform key input in better accord with the progress of the song, and, even in the case of a high level person who is highly skilled at the typing game, it is possible for him to perform the typing game based on the renewed interest of enhancing the accuracy of his timing.

Since, as described above, with the typing game apparatus 1 according to this embodiment, the input time period for key input is changed based on each of the difficulty level settings of “EASY MODE”, “NORMAL MODE”, and “HARD MODE”, accordingly it is possible for this typing game apparatus 1 to be profitably played by players of a wide range of ability, whether the player be a novice or a highly skilled player or at an intermediate skill level. In particular, since the requirement for the typing ability of the player is lowered by making it possible to set “EASY MODE”, in which the input time period is set to be longer than in the case of “NORMAL MODE”, accordingly, even in the case of a novice who has not previously played the typing game, it is possible for him to experience an adequate level of pleasure when playing the typing game.

Moreover, since no influence is exerted on the tempo or the like of the song which is replayed if the difficulty level has changed, accordingly the same song is replayed in the same manner, whichever of “EASY MODE”, “NORMAL MODE”, and “HARD MODE” the difficulty level setting may be. Accordingly it is possible to execute the typing game without losing any of the attraction of the song, and moreover it is possible for players of a wide range of ability, from novices to experts, to experience a sufficient level of pleasure while playing the typing game.

It should be understood that the present invention is not to be considered as being limited to the embodiment described above; it would be possible to make various changes to the present invention, provided that its gist is not departed from.

For example although, with this embodiment, it is arranged for it to be possible to change the setting of the input time period for each character, the present invention is not to be considered as being limited by this feature. For example, it would also be acceptable to make it possible to change the input time period for each phrase, or to make it possible to change the input time period for each word.

Moreover although, with this embodiment, it is arranged to set the input time period with the same time period before and after the input timing, based on the difficulty level setting data, the present invention is not to be considered as being limited by this feature.

For example, it would also be acceptable to arrange to set the time period shorter before the input timing, and longer after the input timing. In particular if, in the case of changing the setting of the input time period one phrase at a time, the time period after the input time period stipulated in the determination standard data has elapsed is set to such an input time period as to elongate the predetermined time period, then a novice is enabled to experience a sufficient level of pleasure when playing the typing game, even in the case of an application in which display is performed one phrase at a time, and in which it is determined for each phrase whether the typing is within the input time period or not.

Furthermore although, with this embodiment, it is arranged to set the input time period according to the difficulty level setting data, based on the determination standard data stipulated for each item of the music data, it would also be acceptable to establish a plurality of correspondences for the determination standard data in which the input time period is stipulated according to the difficulty level setting with each item of music data. In this case, the determination standard data corresponding to the difficulty level setting data would be read out from the determination standard data storage region 56E of the music data storage region 56, and the correctness determination procedure (of the step S38) would be executed based on the determination standard data which had been read out. In this case, the input time period setting procedure of the step S51 would become unnecessary.

Furthermore, it would also be acceptable to arrange to change the display format for the lyrics display section 22 and/or the Alphabet letters display section 23 according to the input time period, so as to notify the input time period to the player. For example by arranging, only during a period which corresponds to the input time period, to change the character color of the characters, or the background color for the characters, during the input time period, it would be possible for the player to determine visually which character to input.

Moreover although, with this embodiment, the difficulty level setting which is set by the difficulty level setting procedure of the step S5 is maintained at the same set difficulty level setting during this typing game, it would also be acceptable to arrange to change it appropriately during the execution of the typing game. For example, it would be acceptable to arrange, each time a predetermined unit of processing (for example, the processing for one phrase) terminates, based on the input results (the correctness/incorrectness ratio of key input, and the correctness/incorrectness ratio of key input timing) in this predetermined unit of processing, to change the difficulty level setting to a higher difficulty level setting if the input result is good, and to change the difficulty level setting to a low difficulty level setting if the input result is not very good.

Since, by employing this type of structure, it is always possible to change the difficulty level according to the skill of the player, accordingly it is possible always to execute the typing game at an appropriate level of difficulty. In particular, a novice at the typing game is enabled to recognize enhancing his own abilities.

What is claimed is:

1. A typing game apparatus, comprising:
a display on which a character string to be input is displayed;
an input unit which inputs characters by operation by a player;
a storage unit which stores game data, including character string data displayed on the display, and input time period data which indicates a time period for receiving input of the character string from the input unit;
a game control unit which performs control of a typing game, based on the game data;
a timing determination unit which determines a correctness or incorrectness of input timing, based on the input time period data and information which indicates a time when input is performed by the input unit;
an input time period selection unit which selects a length of an input time period; and
an input time period changing unit, which changes the input time period based on a result of selection by the input time period selection unit,
wherein the timing determination unit determines the correctness or incorrectness of input timing by the input unit, based on the input time period which has been changed by the input time period changing unit.

2. The typing game apparatus according to claim 1, wherein:
the game data includes music data based on a music performance related to a song, and the character string data comprises data which indicates a character string related to lyrics of a song.

3. The typing game apparatus according to claim 1, wherein, when selecting the input time period, a plurality of alternatives for the input time period data are displayed on the display.

4. The typing game apparatus according to claim 3, wherein a selection of an input time period is performed according to an instruction input operation specifying that one input time period data is to be selected from among the plurality of alternatives for the input time period data displayed on the display.

5. The typing game apparatus according to claim 3, wherein the plurality of alternatives for the input time period data comprise time period data indicating a first mode in which a permitted input time period is the longest, time period data indicating a second mode in which the permitted input time period is the shortest, and time period data indicating a thirds mode in which the permitted input time period is between the input time period indicated by the fist mode and the input time period indicated by the second mode.

6. The typing game apparatus according to claim 1, wherein the input time period for a next typing game is changed according to a determination by the timing determination unit.

7. The typing game apparatus according to claim 1, wherein the display comprises a first display section which can display a character string which is to be input during the typing game, and a second display section which can display an image.
